(19) United States
(12) Patent Application Publication
(10) Pub. No.: US 2008/0228904 A1
(43) Pub. Date: Sep. 18, 2008

(54) Home Gateway Architecture and State Based Distributed System and Method

(76) Inventors: Daniel Crespo-Dubie, Sausalito, CA (US); Joe Clinchot, Staten Island, NY (US); Steve Decker, Rocky Point, NY (US); Tom Morgan, Brooklyn, NY (US); Joseph Thaddeus Nogan, Westfield, NJ (US)

Correspondence Address: DICKSTEIN SHAPIRO LLP, 1825 EYE STREET NW, Washington, DC, 20006-5403, US

(21) Appl. No.: 10/580,214

(22) PCT Filed: Mar. 20, 2003
(86) PCT No.: PCT/US03/08505

§ 371 Date: Feb. 19, 2008

Related U.S. Application Data
(60) Provisional application No. 60/365,619, filed on Mar. 20, 2002.

(51) Int. Cl. G06F 15/16

(52) U.S. Cl. 709/223

(57) ABSTRACT

A state based control system (100) is provided for use with unreliable physical device sensor inputs. The system (100) includes symmetrical architectures between a client side and a server side. Communications between both architectures are state dependent thus minimizing conflicts, and reducing system reliance on consistent device signaling. Physical devices (144, 146) are represented by surrogates which increase system reliability, deepen complexity, and simplify end user experience.

This application claims the benefit of U.S. Provisional Application Ser. No. 60/365,619, filed Mar. 20, 2002, the entire disclosure of which is incorporated herein by reference.

### FIELD OF THE INVENTION

The present invention relates to an architecture and process for home control.

### BACKGROUND OF THE INVENTION

While smart appliances, home computer networks, and high speed bandwidth communications are avenues of increasing consumer awareness and use, fully integrated home control has escaped widespread adoption. To some extent the lack of consumer acceptance stems from the sum being greater than its parts. Home control has been expensive to implement and has been bulky to operate despite the widespread availability of the elements that would otherwise form the building blocks of a home control system.

Part of the reason for the expense is that a home control network is not like other networks. A home network needs to communicate in an unreliable environment.

To a certain extent, systems were designed using field-based component to address this problem. Since the late 1970's, field-based MODAD bidirectional pagers were employed. While these 2-way communications devices enabled field-based communications to upgrade status, the field device could continue to change its status without the central device being made aware of the change. As a result, the 2-way pagers lacked coordination. Further, if the connections to the device were unreliable, and the controller did not anticipate unreliable connections, the network would fail.

A further communications issue results from competing or conflicting demands. A person may have an automated temperature control set-up. They may leave the house forgetting to reset the temperature control. Realizing their mistake, they could then send in a request to lower the temperature when turned on. Meanwhile, the system has in its queue an automated setting to raise the temperature. As a result an automated setting to raise and lower the temperature are both in the queue. The system is thus presented with competing conflicting commands. There is a need for a system that internally resolves conflicts from competing commands.

Beyond the issue of conflict, few networks are designed to assume that communications are not reliable. Designs do not assume that communications can self-correct or provide delivery opportunistically. Instead, systems tend to rely on simple rules for default processing.

In addition, present systems communicate directly with attached physical devices. These devices may be more effective if they communicate to the system via a simulator which acts as a parallel virtual device. By providing a virtual physical device, all complexity for the physical device (such as communication priorities) can be built into the surrogate device. In addition, the surrogate can act as a governor to the physical device: it can filter out unwanted messages, it can decide on the most efficient transmission path, it can apply rules to a device, so that the user does not have to worry whether or not the physical device carried out that user's command. Thus, the surrogate can turn off the coffee-maker, lower the thermostat, or lock the doors for each physical device.

A further issue for complex control systems is that system building requires constant vigilance and an effort to reflect the current system state. There exists a need therefore for a system that self-modifies over time, so that it provides computational reflectivity in modifying its own structure.

### SUMMARY OF THE INVENTION

In view of the foregoing, there is a need in the art for a network that is designed to operate where communications are assumed to be unreliable. This is achieved through a goal-based network that is not real-time but is instead based upon desired network states. States are achieved through an iterative approximation of goals that are synchronized at a functional level with the user and the behavior of the system.

### BRIEF DESCRIPTION OF THE DRAWINGS

For a better understanding of the invention, reference should be made to the following detailed description taken in conjunction with the accompanying drawings, in which:

FIG. 1 is a function block diagram illustrating the system architecture of the present invention;

FIG. 2 is a function block diagram illustrating the home control server architecture of the present invention;

FIG. 3 is a function block diagram illustrating the client architecture of the present invention;

FIG. 4 is a function-step block diagram of the process framework process and modules;

FIG. 5 is a function-step block diagram of the APF process framework process and module;

FIG. 6 is a process step diagram, illustrating the data synchronization protocol process;

FIG. 7 is a function step block diagram illustrating the data synchronization algorithm;

FIG. 8 is a function step block diagram illustrating the merged activities portion of the data synchronization algorithm;

FIG. 9 is a function step block of the model roll-back step of the data synchronization algorithm;

FIG. 10 is a function step block diagram of the after model validation step of the data synchronization algorithm;

FIG. 11 is a function step block diagram illustrating the charge instruction commands;

FIG. 12 is a function block diagram of the DSM client model portion of the data synchronization algorithm;

FIG. 13 is a screen diagram of the current states tab of the graphic user interface of the present invention;

FIG. 14 is a screen display of the manage location tab of the graphic user interface;

FIG. 15 is a screen display of the manage scenes tab of the graphic user interface of the present invention;

FIG. 16 is a screen display of the manage notifications function of the system graphic user interface;

FIG. 17 is a screen shot of the manage notifications service rules portion of the screen display;

FIG. 18 is a screen shot of the manage notification actions list of the present invention;

FIG. 19 is a screen shot of the node manager screen display of the manage notification tab of the present invention;

FIG. 20 is a screen shot of the location manager portion of the manage notifications tab of the present invention;

FIG. 21 is a screen shot of the scene manager portion of the mange notifications tab;

FIG. 22 is a screen shot of the application service manager of the manage notifications tab of the present invention;

FIG. 23 is a block diagram of the conflict manager architecture and related processes for conflict resolution;

FIG. 24 is a block diagram of the system manager; and

FIG. 25 is a block diagram of the session management layer of the present invention; and

FIG. 26 is a block diagram of the physical device simulator architecture.

### DETAILED DESCRIPTION OF THE INVENTION

Overall Architecture—Overview

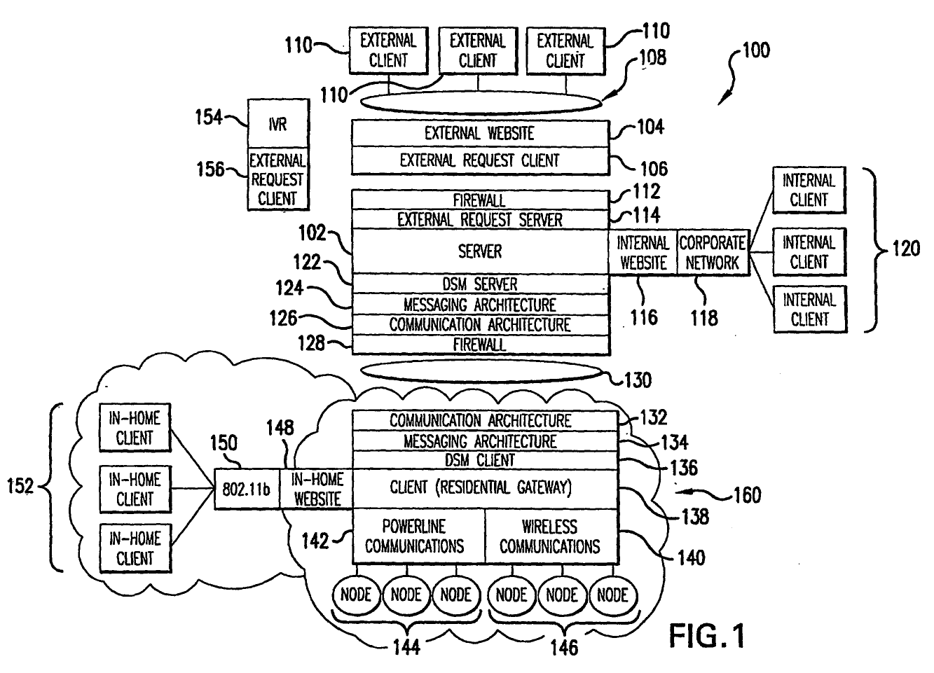

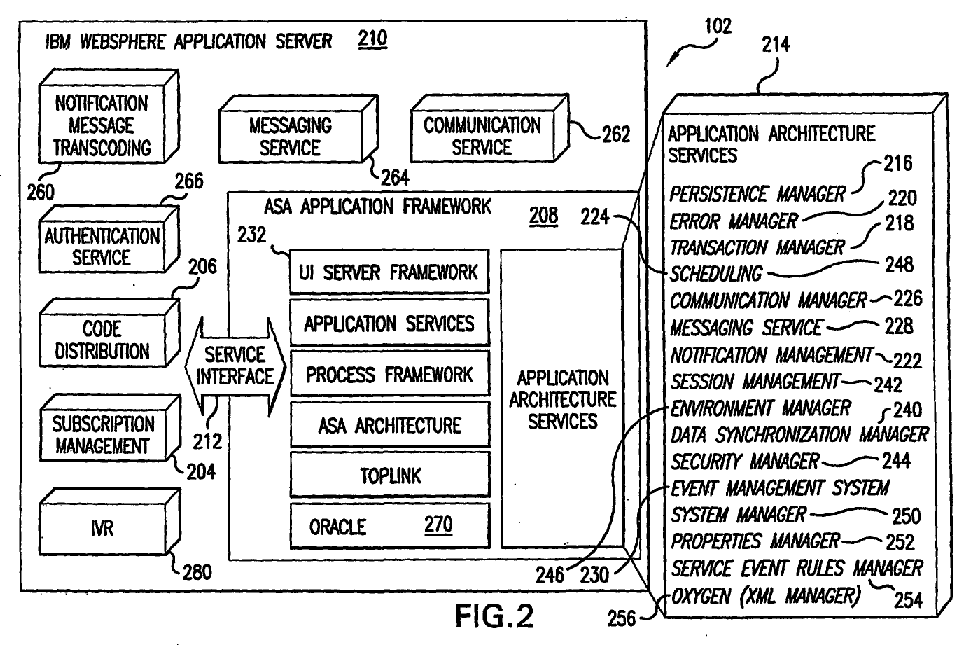

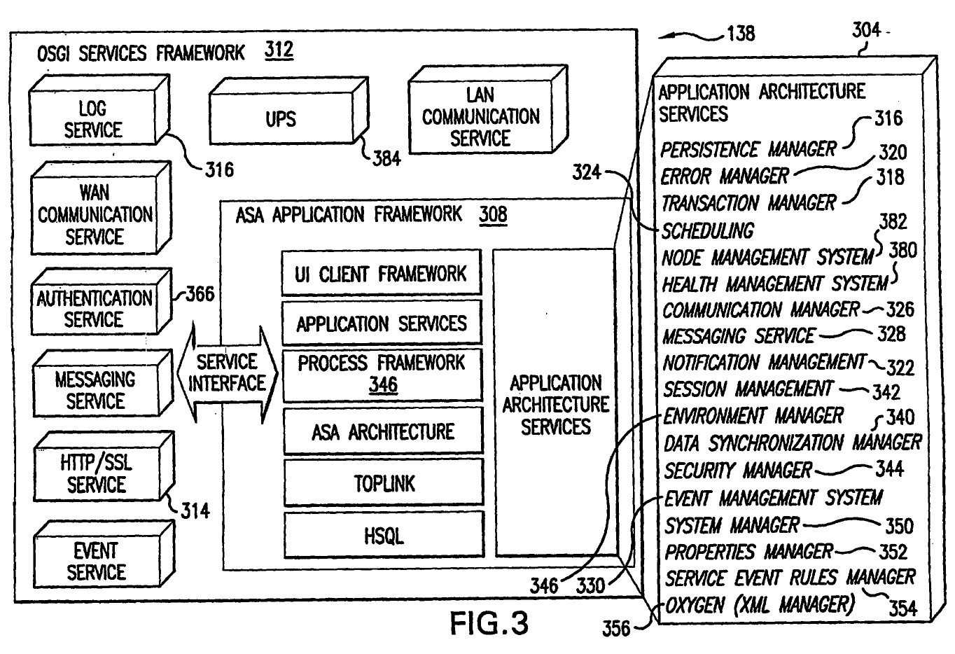

The following is a detailed description of the invention of the figures, wherein like numerals refer to like objects. With respect to FIG. 1, the architecture for the MyHomeGate application 100 is designed to support the hosting of various consumer application services (not shown). These services range in functionality from the basic, as in the case of motion detection, to those with more rich and intelligent capabilities, such as the shutting-off of targeted appliances and sending notifications when water has been detected. Services themselves are easy to bolt-on to the system 100 and will be pluggable into the existing application framework. The framework which is further described in FIGS. 2-3 will promote the interaction between services by providing the ability to assemble composite services from a host of other services in the framework. The system is designed to be intuitive, flexible and easy to use. It will be simple for the novice users, yet robust enough for those who require more control.

User Interfaces

Users will require access to their services both at home 160 and while they are away. In addition, customer representatives and other internal users at the server side 102 of the system 100 will require access to the system through the corporate network 118. As a result, the architecture 100 provides the necessary support for accessing the system 100 from a variety of sources. Consumers interacting with the system from inside their home 160 (also referred to as “the client side”) use an in-home user interface (“UI”). This interface may be a dedicated control panel (not shown) attached to the gateway processor 138, the consumer's personal PC 152, a Web Tablet (not shown). In addition, subscribers away from their homes, can remotely access the system 100 in the form of an external website 104, a WAP, an IVR, a Call Center, or any other conventionally known communication technology connected to the main or central server 102 (also referred to as “the server side”). All access to the system 100, regardless of the channel, is secured and authenticated as will be further described herein. This is essential for protecting the privacy of consumers and providers as well as preserving the integrity of the entire system 100.

Client Server Design

Based on the system 100 requirements, it is obvious that a client server 102 architecture will be required to satisfy the system needs. A client, known as the residential gateway 138, is located in the consumer's home 160. The gateway 138 is responsible for: 1) the hosting of application services, 2) communication with all nodes 144, 146 within the home 160, and 3) control of all in-home interactions with the system 100.

A central server counterpart 102, hosted remotely from the home 160 is responsible for all server-side interactions with the system 100. This will include local access by representatives 120, as well as, remote consumers 110, accessing the system through the website 104 connected to the Internet 108. Clients 156 also can access the system 100 through the IVR 154 or through other known communications means.

Communication and Data Synchronization

Communication and synchronization between the client side and the server 102 will take place over communications channels 130 available in the home to be provided by the consumer through the communications architecture 132. The system 100 supports POTS, DSL, and/or cable connections or any other conventionally known communications means. By the nature of these communication channels, the client and the server 102 will not be in constant communication across channel 130. As a result, the system 100 must provide some means for determining the appropriate channels for communication and the frequencies at which this communication should occur.

The need for in-home and remote access to the system 100 together with a disconnected client and server, poses some interesting challenges answered by the present invention. First, as will be further described, the client and the server run independently of one another. Second, both the client and server can service a common set of requests accordingly. As a result, some degree of symmetry exists between the client computer 138 and the server 102. It is obvious that a common set of functional capabilities, core domain model logic, and state will be required on both sides to support required symmetrical processing on either side. From a usability standpoint, the end user experience must remain constant and predictable. Therefore, the present architecture facilitates the synchronization of these independent, but symmetrical models, at logical intervals.

External Website and IVR

As stated earlier, consumers must have remote access e.g., 110 to their services offered by the system 100. This remote access is always facilitated through the server 102. The consumer will access an external website 108, IVR 154, Call Center, WAP etc., where requests are processed. All necessary communication with the gateway 138 in the consumer's home, is brokered through the server 102 and is transparent to the consumer e.g., 152. Access through these channels is intuitive, easy to use, and secure.

Many of the components that are used to support this remote access are no different than those used to support standard external corporate networks. Webservers, Firewalls 112, Proxies, DMZs, Portal Servers, etc., will be just some of the components required to implement this portion of the system infrastructure. Additionally, an external request client 106 and an external request server 114 are employed. Internal communications on the server side also can be effected through the internal website 116.

In-Home LAN Communication (Powerline and Wireless)

In-Home LAN Communication refers to the channels through which a gateway 138 communicates with nodes 144, 146 in the home 160. The nodes 144, 146 represent a myriad of physical devices (e.g., Appliances, Smoke Detectors, Motion Sensors, Thermostats, etc.). It should be noted that any physical devices can be used in conjunction with the present invention. Therefore, non-home related devices are also appropriate nodes. The preferred embodiment supports two of these communication channels or means power line 142 and wireless 140. However, it is anticipated that any form of physical device connection can be used for the communications means.

For the powerline communication channel 142, the Powerbus product from Domosys Corporation is an example of an existing power-line product. The present invention, however, can incorporate any conventionally known power-bus device. Powerbus is one of the participators in the CEBus consortium and still continues to support CEBus. Domosys, however, has realized some of the shortcomings inherent within the CEBus technology. As a result, it has proceeded to address many of these issues and concerns within its new PowerBus and Vlogic technologies. With these new technologies, Domosys has been able to develop a protocol that runs faster over the powerline 142, and includes the encryption of data.

While it is contemplated that any wireless technology 140 can be used, an example of a desired wireless technology that can be deployed in the communications means is the zWave product by Zensys technology.

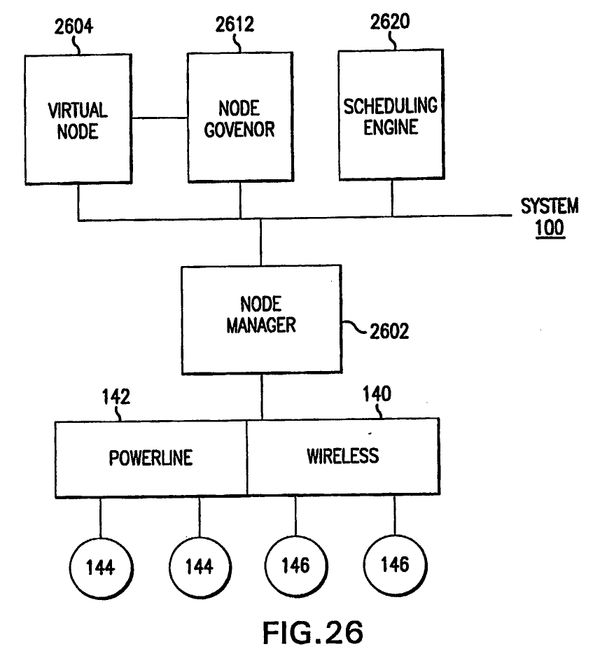

Both of the in-home communication channels selected: powerline 142 and wireless 140, are expected to provide control and monitoring of the nodes 144, 146. These channels manage some basic network management capabilities (e.g., adding, moving, removing nodes 144, 146), security and privacy, and acceptable performance and reliability. As will be discussed further with reference to FIG. 26, these channels can also communicate with virtual device simulators.

Security

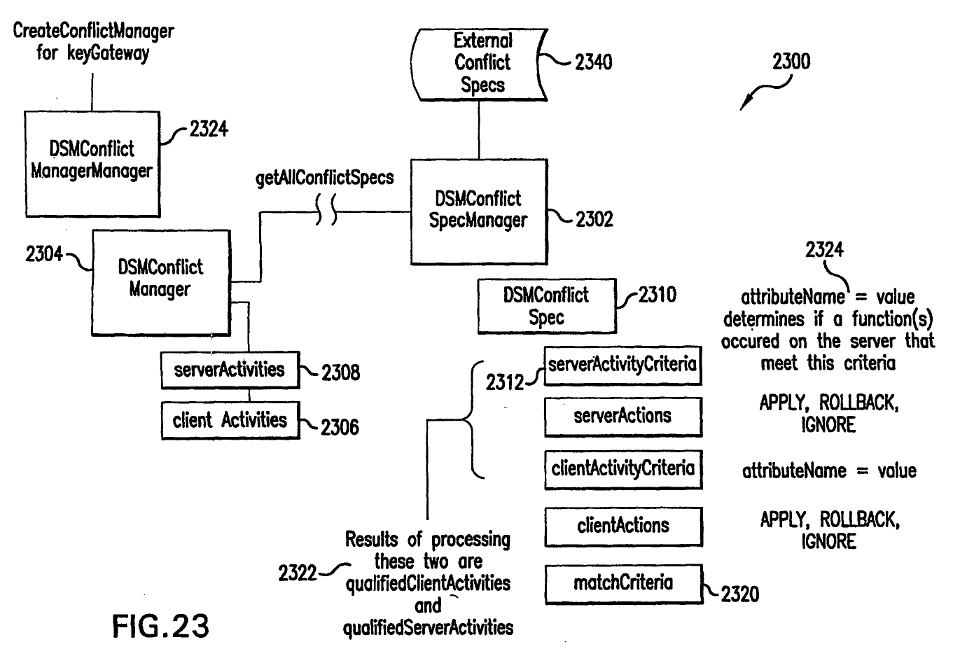

A sound security infrastructure is essential for retaining the integrity of the system 100, the privacy of consumer information, and controlling access to consumer's accounts and homes 160. Security is an integral part of many system components. The following security elements are included in the present invention:
The communication architecture 132 provides authorized and encrypted communication between the server 102 and the residential gateway 138 located in the consumer's home 160. The messaging architecture 134 provides message queuing and handling between the client 138 and the server 102.
The External Website 104 provides consumers 110 with remote access to their services in a secure manner.
The system 100 provides access level controls to all application components. As in the case of application services, some of these components will have access rights maintainable by a privileged subscriber. Other components and/or functions are accessible only by central server 102 representatives 120.
In-home 160 communications, through both the powerline 142 and wireless 140 have provisions for access control and data privacy.
Finally, the DSM Client 136 provides state based control synchronization and will be further described in FIG. 23.

Server Services Description

Referring now to FIG. 2, the server services are illustrated. Server Services are application architecture services that have been developed for use specifically on the server 102. The following is a list of these services:
Notification Server 260, 360
Communications Server 262, 362
Messaging Server 264, 364
Security Server(s) (not shown)
Code Distribution Server 206, 306
Subscription Management Server 204, 304
Authentication Server 266, 366
Transcoding Server (not shown)

This list of services is by way of example. Any number of services can be substituted for the present system. The server 102 is responsible for servicing all system 100 interactions outside of the consumer's home 160. The following are examples of these interactions:
Facilitation of all remote access to consumer's Gateway 138 (access through external website 104, IVR 154, WAP, etc)
System Management of all Gateways 138 (Subscription Management 204 and Code Maintenance 206)
Notification Services 260
Facilitation of all interactions by central server representatives (Customer Service, Inventory, Billing, Cash, Etc.)
Managing all interfacing with external entities (e.g., Service Providers, Aggregators, etc.)
Securing and controlling all access to residential gateways.

The server 102 requires many components to satisfy these requirements. These components can be categorized into the ASA Architecture and the IBM Websphere Application Server, and Server Services, and the ASA Application Framework (APF).

ASA Architecture

In order to achieve the symmetry mentioned in the architecture of the system 100, an application framework has been provided to serve as the backbone for all application and architecture services. This services framework (i.e., ASA architecture), along with a set of shared services, has been designed to run both on the client 138 and on the server 102. ASA is a generic applications service architecture. In the preferred embodiment it was written in Java. However, any conventionally known programming language can be used for the ASA.

The ASA was designed to operate as a control architecture for any environment or application. In the present invention, the ASA is described in conjunction with the home 160, or on a device with intermittent communication capacity, e.g., nodes 144, 146. The ASA comprises a three-tier architecture with the middle tier being broken into two distinct parts: function and domain. The function layer acts as a process model. This model consists of ASA controller entities that manage all interactions with the system 100. This process model framework will serve as the backbone for plugging-in required architecture services (e.g., Persistence 216, Transaction 218, Environment 246, Activities, Access Control 264, Authentication 266, Messaging, Data Synchronization 270, etc.) as set forth in FIGS. 2-3. This design has led to a system 100 that is driven more by specification and less by code. More architecture frameworks and services mean higher levels of reuse and therefore less application code. The server architecture is therefore tool driven rather than code driven which is easier to understand, use, and maintain. The ASA Architecture and applications have manageable ties to vendor products and the architecture utilizes current technologies (e.g. Web Technologies, MQ, XML, Java, etc.). This architecture can employ any conventionally known languages and tools.

The ASA architecture is designed as a series of services, which lend themselves to the upgrade process of phasing out proprietary implementations with standard services as they become available in the market (e.g., XML Script, commons logging, persistence and transaction support). Generic and reusable architecture can serve as a platform for new and existing applications throughout the organization (e.g., Smalltalk applications (CCH, MBS, EBS) CRIS, etc.)

The ASA architecture provides an opportunity to better exploit the generic application layer (i.e. GOAL) which currently exists in Smalltalk applications. The architecture also is not intrusive to the domain code. In addition to ASA, APF, and other services being identical on both the client 138 and server 102, the two also share a common Domain Model. The model which shall be described later exists on the client side as a true subset of the overall model existing on the server side. This subset is the core of the model necessary for the client device 138 to service requests independently of the server 102.

This approach of symmetry between the client 138 and server 102 yields several benefits. First, it increases the reusability of code and shared services between the client and server. Second, it leads to an easier understanding of the system 100, by reducing the number of required components, as well as, the complexity of code within the system 100. Third, it simplifies the synchronization solution by enabling it to be a synchronization of two symmetrical object models.

IBM Websphere Application Server 210

The ASA Application Framework 208 will require many server services to satisfy all the application requirements. Some of these services are common throughout many of the Java application servers. Others may be specific to this problem space. For those that are common such as: Authentication, Communication, Messaging, etc., the system leverages on those services provided by an application server. As a result, a decision has been made to host the ASA Application Framework within the IBM Websphere product 210. Websphere has proven to be the leader in the Java Application Server space. It provides a rich set of robust services that is required by this application. However, as the application servers are developed, it is anticipated that the ASA can be deployed in a conventional manner on other proprietary systems.

In order to leverage this rich set of Websphere services, an interface 212 between Websphere and the ASA Application Framework is required. While the best interface will depend on the application server type and the chosen application framework, one example is to use the best alternative for this is the JMS (Java Messaging Service) solution.

Server Services

As shown in FIG. 2. the server 102 will host many reusable application architecture services 214 for use by the architecture and/or the client-side application. Some of these services are common and therefore will be provided by the proprietary server. Examples of such services are authentication 266, communications 226, messaging 228, transcoding, and IVR 280. These services will be made accessible to the client-side application and ASA application architecture 208 through an open interface 212.

Other services include: persistence management 216, transaction management 218, error management 220, notification 222, scheduling 224, event management system (“EMS”) 230, and node management service (“NMS”). Many of these server services will also be utilized on the client 138.

Server UI Framework

The Server UI Framework 232 supports UI's required for internal corporate users 120 (FIG. 1) (e.g., Customer Service Representatives, Inventory Control Reps, Technical Support Reps, Billing Specialists, etc.). This framework is hosted on the internal corporate webservers 116, 118. It is responsible for managing user navigation and the facilitation of requests to the application server. For the trial, internal corporate users 120 will be limited to extended project team members. As a result, this framework is more functional than atheistic.

Client Services Description

Referring to FIG. 3, client services are application architecture services 364 that have been developed for use specifically on the client side. The following are a list of these services:
Health Management System 380
Node Management System 382
UPS Service 384
HTTP Service (OSGI) 314
SSL Service (OSGI) 314
Log Service (OSGI) 316
Servlet Service (OSGI) (?)

The client server 138 is responsible for hosting application services, facilitating all communication 132 with nodes 144, 146 in the home 160 and control over all in-home access to the system 100. Registered application services 304 run both on the client device 132 and on the server 102. All interactions with these services, along with other components in the system 100 are handled through an in-home UI or a networked PC 152 on the in-home website 148 (connected for example through an 802.11b wireless network 150 within the consumer's home 160). These interactions are processed on the gateway 138 through the APF framework 308. The client is also responsible for interactions required with nodes 144, 146 in the home 160. These interactions will take place over the wireless 140 or powerline 142 communication channels.

Communications between the client and server are facilitated through the available WAN connection 130 in the home. Support for POTS, DSL, and/or Cable are included and managed by the communications architecture 132. As stated earlier, these connections are non-persistent in nature. As a result, data synchronization is required between the client and server models. The Data Synchronization Manager 240 is responsible for determining the appropriate times for synchronization, managing the synchronization process, and applying the appropriate policies for this synchronization.

ASA Application Framework

On the server 102, many robust application server components are available with persistence and transaction support, as well as many other reusable services. On the client side, as shown in FIG. 3, however, there is no such luxury. Vendors have yet to fill this space with viable alternatives. As a result, the present invention relies on the above-described ASA application framework (APF) 208, 308 to serve this role. This framework has been designed to stand on its own in the case of the client 138, or to be embodied into a more robust application server, as in the case of the server 102.

OSGI Services Framework

Despite the fact that no application server is running on the client side, the present invention leverages services on the client through the OSGI Services Framework 312. This framework has been specified by the OSGI consortium and has been implemented by two major vendors (i.e., IBM and Sun). Based on the Gateway 138 selection, the Service Management Framework 312 offered by IBM is selected. However, any conventional services framework adaptable to the ASA application framework can be employed. Although this services framework does not offer full functional application server support, it does provide a framework for reusing services. In addition, the specification provides for some common reusable services. An HTTP Server 314, a Servlet Engine (which acts as the client console) (not shown) and an HTTP/SSL Service 314 are just a few of the services packaged within the framework.

Client Services

As explained in the section above, the OSGI specification defines services that specific implementations must provide. These are common services that are generally needed by any application requiring use of the ASA framework 308. Vendors may also choose to provide additional services within their implementation that may not be required by the present specification. IBM for example offers the following services within their Service Management Framework:
HTTP
Servlet Engine
Logging—316
SSL Service
In-Home Communications

In-home communications refers to the channels through which communication occurs between nodes 144, 146 on the LAN side of the Gateway 138. For this type of communication, the gateway has been equipped with three options: PowerBus 142, zWave 140 and 802.11b, 150 (FIG. 1)

As previously noted, PowerBus is a protocol used to communicate between nodes over standard residential power line wiring. PowerBus is a relatively new technology from the Canadian company, Domosys. Domosys has been involved in power line communications for many years. Early efforts by Domosys focused primarily on CEBus. CEBus was a power line technology targeted for the residential market, but was never successful at generating the demand required to make it affordable. This may have been a result of the many shortcomings inherent with the technology. It was slow, unreliable, and the protocol itself was over specified. Despite their continued support of CEBus technology, Domosys has began the development of PowerBus, a technology they feel will address many of these shortcomings present in CEBus.

Nodes 144 participating in PowerBus communications 142 normally have an integrated U-chip which is provided by Domosys. In some cases, a bridge may be supplied for situations where integration is not feasible. The Envirocom proxy is an example of this. This proxy bridges the PowerBus protocol together with a Honeywell proprietary protocol used within a Honeywell thermostat.

The second LAN communication option is a low-cost, low bandwidth RF solution 140. This channel will be used for nodes that generally do not have access to the powerline network 142. For example, door and window sensors, motion sensors, water sensor, etc., all qualify.

The last of the communication channels available within the residential gateway is the 802.11b wireless local area network. This is a higher cost, higher bandwidth than the zWave (−11 Mbs). This channel can be used to address the higher bandwidth requirements of the in-home UI. 802.11b has recently become very popular within the residential Internet 148 space. In addition, many of the in-home UI providers have began to integrate an 802.11b interface as a standard option. The downside to 802.11b is the cost. An 802.11b interface card costs in the range of $90-$120. This invention can incorporate any residential internet application.

Client UI Framework

The in-home UI device of the preferred embodiment is a webpad with a web browser and an 802.11b wireless interface. However, it is contemplated that any device that is functionally similar can be employed. As a result, the UI Framework on the client will be some web-based implementation. Unfortunately, the OSGI web server does not support JSPs (i.e. Java Server Pages). As a result, the system resorts to a servlet-based or COW-based solution. COW is a combined UI and request framework, to support dynamic content prior to the existence of JSPs, ASPs, or Cold Fusion.

Client/Server Services Description

Client/Server Services refer to application architecture services that are shared between the client 138 and the server 102 through the ASA Application Framework 208, 308. These common services have been developed to simplify the overall architecture by increasing the reusability of the components provided. Services included in the preferred embodiment are as follows:

Session Manager 242, 342
Security Manager 244, 344
Environment Manager 246, 346
Persistence Manager 216, 316
Transaction Manager 218, 318
Error Manager
Event Management System 230, 330
Scheduling Agent 248, 348
Data Synchronization Manager 240, 340
Communications Manager 226, 326
Messaging Services 228, 328
System Manager 250, 350
Properties Manager 252, 352
Service Event Rules Manager 254, 354
XML Class Manager 256, 356

External UI Framework

Referring back to FIG. 1, the external U Framework refers to the framework used to support access to the system 100 through the external website 104. The UI framework provides support for dynamic content, navigation/conversation control, and a protocol for sending requests to the Server 102.

The processing of dynamic content is managed through a variety of frameworks (e.g., contours, struts, COW, or simply JSPs). The decision of which to use is influenced by the detailed UI and usability requirements, estimates of the alternatives, and the individuals assigned to the task.

Internal UI Framework

As explained earlier, in the Server UI Framework section of the Overall Architecture—Overview, the internal U′Framework will be used to support UI's hosted on the internal corporate network for use by personnel 120 (e.g. Customer Service Reps, Billing Specialists, Inventory Managers, etc.). Similar to the External UI Framework 104, issues of dynamic content and conversation/navigation control are addressed with this framework. However, a major difference between the internal and external UI frameworks lies in the interface between the framework and the application server 102. Unlike the external framework, the internal framework will have the protection of being hosted on the corporate network 118. In addition, the set of users 120 will be limited to employees of the central server 102 company. These two factors provide a more robust interface for internal users 120.

The system also includes: 1) a mechanism that helps facilitate the interactions between the internal UI framework and the Application Process Framework, 2) a UI Controller that interacts with the mechanism for calling functions in APF and obtaining the necessary input from the caller, and 3) a conversation controller, which manages the coordination between UI and Function navigation.

This architecture results in a single application framework and domain model on both the client and server. The idea was to reduce development and maintenance cost, as well as, simplify synchronization between the client and server. This architecture also avoids differences between the client and server to the application layer. This was accomplished through an abstract persistence layer, which will be described later, that serves as the application interface to the underlying persistence mechanism. On the Server side (FIG. 2), Oracle 270 was selected and on the Client side (FIG. 3), a Java-embedded database was selected. However, any conventionally known DBMS or programming language can be used.

Description of Functions

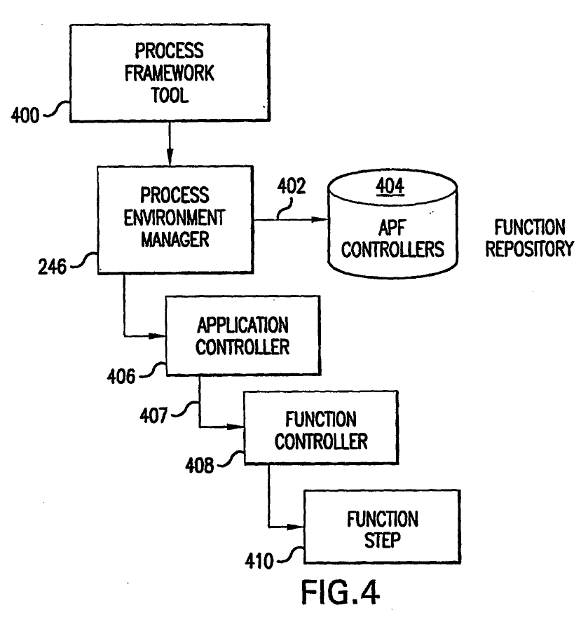

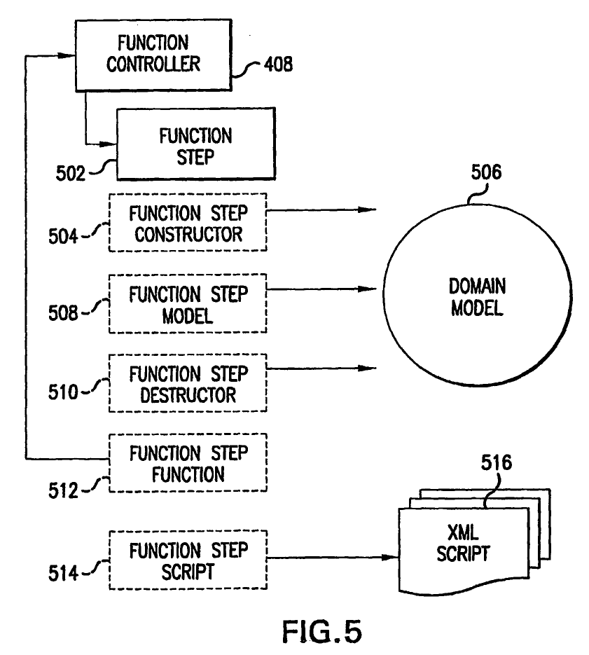

Referring to FIG. 4, the system employs a class three tier architecture with the middle tier being broken into two parts: a function layer and a small layer. The function layer, as described in further detail in FIGS. 4-5 is implemented as a process model. This model consists of a plurality of controller entities, (APF, application and function) that manage all interactions with the system 100. The process model framework serves as the backbone for plugging in the requested architecture services of persistence 216, 316, transaction 218, 318, environment 246, 346, activities, access control, authentication 266, messaging 264, data synchronization, etc. This architecture enables the system 100 to be driven more by specification, and higher levels of re-use with less attendant code. Also, this architecture allows for it to be built as a series of services which can be easily upgraded or phased out as standard services become publicly available.

Additionally, the APF architecture results in a system that is self-replicating whereby kernels of code can be used to replicate and self-modify. System revision is accomplished through a functional scripting method wherein the functionality of the system is captured in script, which in turn becomes a building block for defining other functions, and enabling system self-modification.

Persistence Management

The client application 138 requires persistence services on both the client 138 and server 102. However, these two environments are vastly different.

The server 102 is a robust environment consisting, for example, of a series of power machines. It is designed to support the processing, storage, and I/O of many client connections 138.

Since a client device 138 lives in each consumer's home, there is less control and flexibility. In addition, cost must be minimized. As a result, the client device 138 has relatively limited processing power, storage and I/O capabilities. Power loss is also a significant consideration on the client 138.

While the requirements for persistence on the server 102 are in-line with traditional expectations, the Client requirements are somewhat different.

Client Persistence Requirements:
Lightweight DBMS
   Less Data than server 102.
   Less connection capacity than the server 102.
Lends itself to Synchronization
Support for unexpected power loss (UPS)
Support for in-field updates/upgrades, etc.

The goal of persistence manager 216, 316 is to have a signal application framework and domain model both on the client 138 and the server 102. This will reduce development and maintenance cost as well as simplify data synchronization.

The challenge will be to avoid exposing differences between the client and server to application layer services 208, 308. This will be accomplished through an abstract persistence layer that will serve as the application interface to the underlying persistence mechanism 216, 316.

On the server 102, the implementation will be DB2 or some other form of conventionally known relational database. An object relational bridge will be used to bridge application objects to their relational counterparts in the database.

On the client 138, the implementation may consist of an XML-based solution. It is understood that any conventional database can be used. The object relational persistence framework is integrated with the XML Class Manager.

The goal is to keep application architecture and domain identical on the client and server. APF has been designed to run on both the client and the server.

Processes are built according to the process framework set forth in FIG. 4. According to this Figure, a process framework tool initializes the process environment manager 246 or Process Framework as shown in FIGS. 2-3. A function library look-up then occurs at Step 402 into the function repository 404. The function repository comprises a plurality of APF controllers. Similar types of function requests are grouped in the application controller 406. The application controller 406 serves as the target for all function requests. A function request 407 is then provided to the function controller 408 which will analyze any functional system request which causes changes in the domain models which is described in more detail below.

Upon completion of the function controller operations, shown in FIG. 5, an XML script of the function step 410 is produced on the client side 138.

Referring now to FIG. 5, the steps for the function scripting at the client server 138 by the function controller 408 are shown. A function step 502 is written when a request to create a new root model is sent by the function step constructor in the environment, as shown by the domain model 506.

A function request 407 is sent directly to the model 506 from the function step model 508. The model 506 is targeted in the environment, a message is sent to the model from the framework 208, 308 and parameters of the function are determined from the environment. A request to destroy a function step/root model required in the environment occurs in the function step destructor 510. The function step can in turn initiate a request to another function controller within the framework 208, 308. From this process, XML script 516, (or any other conventionally known script) is produced from the function step script 514. The script has addressability to the environment, process environment and the domain model 506.

As a consequence, the process enables functions to automatically self-script. Functions are thereby self-modifiable and automatically revised without the need for user involvement.

APF Process Framework

Functions are defined in the APF workbench as follows. First, functions are called by the scratchpad containing domain information accumulated while processing a unit of work/transaction in the system 100 is available for the process framework. The process environment has all functions requested of the system. As a result, the process environment acts as the workspace for the process model.

This environment becomes a versionable and persistent scratchpad. It will exist in the unit of works as do all models. The fact that it will be persisted means the user, system operator can re-attach to it later, validate it, and process it with a saved unit of work. In addition, multiple environments can be supported (if required). An important aspect of APF is activities. When the function controller 408 has been successfully processed, if specified to do so, an activity will be created according to a specification setup in the APF workbench (not shown).

An activity is populated with information from the application and function controller 408 that created it, activity parent information (in support of spawned environments), functional parent information (as specified), and application properties, which can be dynamically determined during execution of the function. Activities also have access to the serialized change set, and Before After Models. This is in support of rollback, reapply, and remote apply of the transaction as will be described later.

Dynamic descriptions of activities are critical to the present invention. This is done by specifying an activity description ID on the function controller 408. This ID must be registered with the Activity Description Manager (not shown) by entering it in the workbench. Activity descriptions hold onto both a system description and a user description. The descriptions themselves can be set to be system 100 or user, e.g., 152, and retrieved accordingly.

Both system and user descriptions can be entered as a static string or can contain dynamic references to activity properties or instance variables. The activity description manager can be configured through the system properties to look for these definitions within an external file (e.g., ADM.ser) or directly in the database. The workbench supports the export of this external file.

ASA functions can also be configured to generate side effects by specifying a side-effect class in the function controller 408. During processing of the function controller 408, any specified side-effect classes will get created by a call to the constructor 504 of that class which takes an activity as a parameter. If the transaction is successful, the side effect instance will be persistence along with the function changes.

This approach cleanly de-couples the capability provided by ASA from the side-effects that get specified by the individual applications. Side effects are useful for background jobs, batch, integration records, etc.

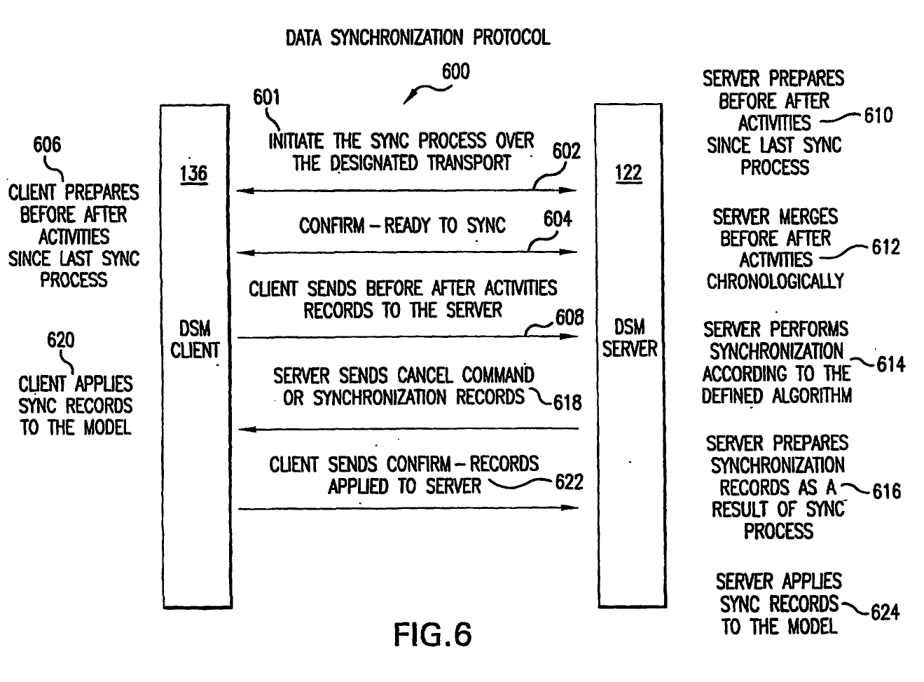

Referring now to FIG. 6, a flowchart of the system data synchronization protocol is shown. The synchronization process is managed by the DSM client device 136 and the DSM server 122 (FIG. 1). At step 601 of FIG. 6, either the DSM server 122 or the DSM client 136 will initiate the synchronization process over a designated transport at step 602. The recipient device will then configure with a “ready to synchronize” response at step 604. Once confirmed, at step 606, the client 136 will prepare a before/after activities record since the last synchronize process with the DSM server 122. The DSM client 136 then sends at step 608 the before/activities records to the DSM server 122.

On the server side, the before/after activities since the last synchronization are recorded at step 610. The before/after activities are merged chronologically at 612. The server then performs the synchronization according to a defined algorithm 614. The server then prepares the synchronization records as a result of the sync process. The prepared records are then sent to the DSM client 136 at step 618 and the DSM client applies the server-prepared synchronization records to the domain model 506 at step 620. Client will then confirm receipt of the sync records back to the server whereupon the server also will apply the sync records to the model 624. The synchronization protocol as shown in FIG. 6 will be carried out over HTTP. However, the transport will be transparent to the protocol, and any conventionally known transport can be used. Change records/Activity records sent at Step 608 will be created during a transaction which updates the model 506. Synchronization commands communicated to the DSM client at step 618 will be used by the DSM server 122 to instruct the DSM client 136 of actions to take as part of the synchronization process 600. The protocol will consist of the following synchronization commands:
Add Model (new Model requested)
Delete Model (request removal of existing Model)
Update Model (Update existing Model)
Sync Alert (initiate sync, ready for sync, sync, sync confirmed, sync cancelled, etc.)
Query (Lookup in the Model Server->Client . . . Client->Server)

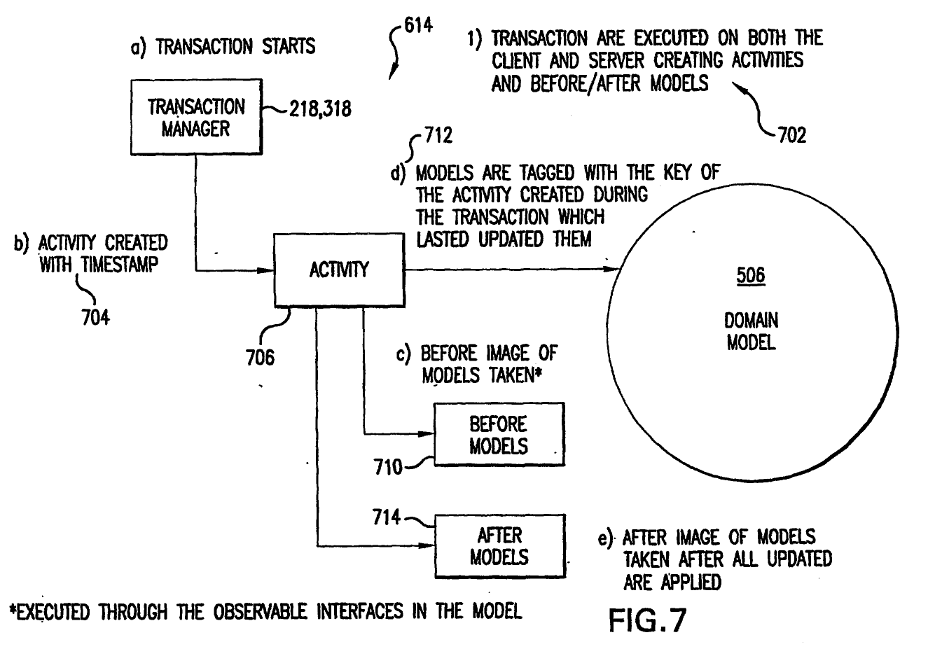

Referring now to FIG. 7, the data synchronization algorithm 614 is illustrated in more detail. The algorithm is first applied when a transaction is executed at step 1 (702) on both the DSM client 136 and the DSM server 122 wherein activities are created on the before/after domain models 506. The transaction is initiated by the transaction manager 218 (server side) and 318 (client side). At step 6, (704) an activity file is created 706 with an affiliated time-stamp. The activity 706 is then affiliated with a before image (at step 710) through observable interfaces with the model 506. At step (d) 712 the domain models are then tagged with the activity key created during the transaction which last updated them. An after image of the model is then taken at step (e) (714) after all of the update have been applied to the model 506.

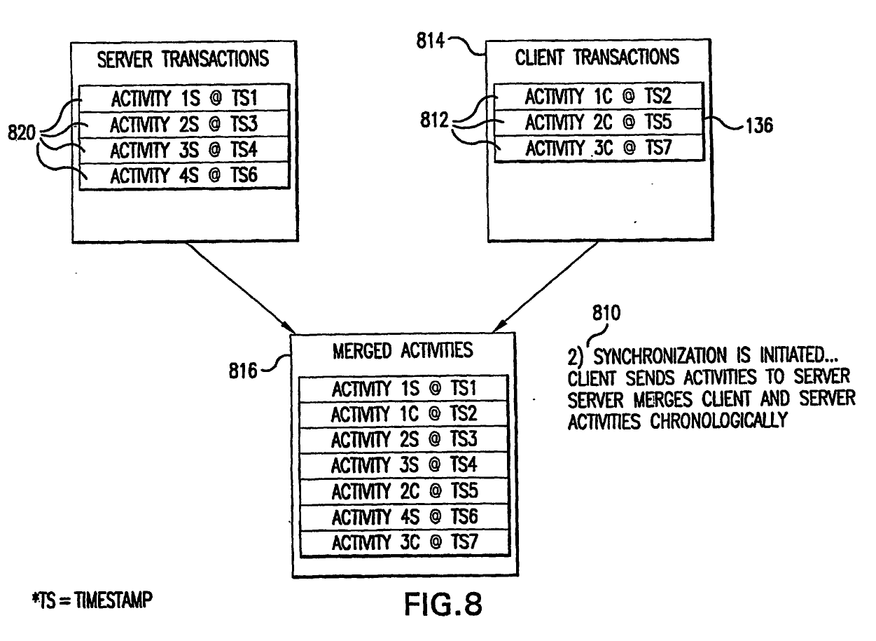

FIG. 8 illustrates a further part of the data synchronization algorithm, whereby the data synchronization step is initiated at 810. The DSM client 136 then sends activities 812 listed under the client transactions to the merged activities list 816 located in the DSM server 122. The server activities 820 also are sent to the merged activities file 816 where they are merged together based upon a pre-determined activity order (e.g., numerical, alphabetical).

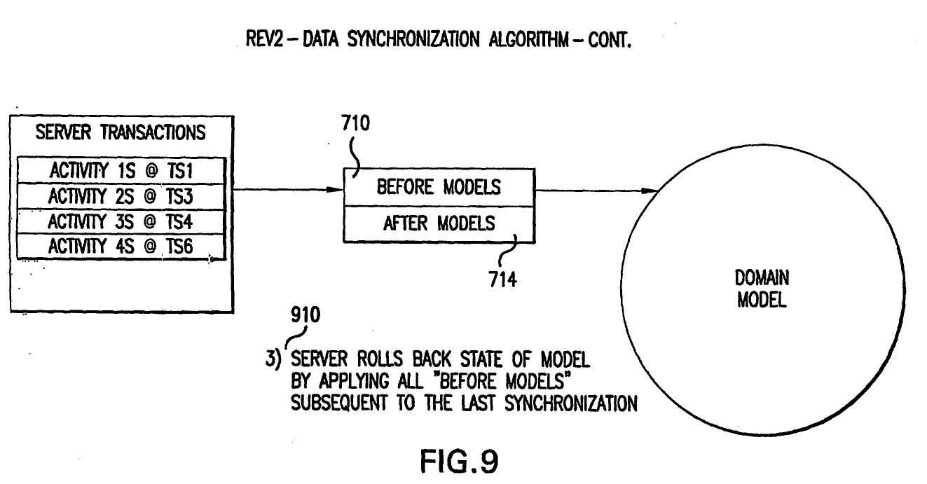

In FIG. 9, the DSM server 122 performs a further step wherein the server 122 rolls back the state of the domain model 506. Rollback occurs when an activity 820 is affiliated with a before model transaction image 710. The before model for each activity is the model subsequent to the last synchronization.

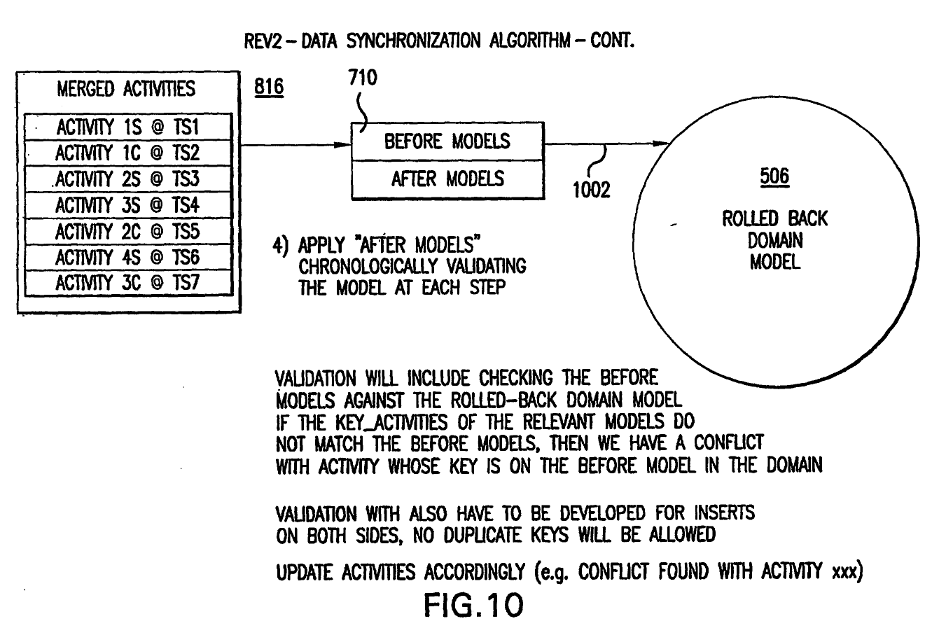

In FIG. 10, the after models 714 are then applied to the domain model at step 1002. Validation includes checking the model 710 against the rolled-back domain model 506. In the event that key activities of the relevant models do not match the before models, then there is a conflict with the activity whose key is on the before model in the domain. Validation will also have to be developed for inserts on both sides, no duplicate keys will be allowed.

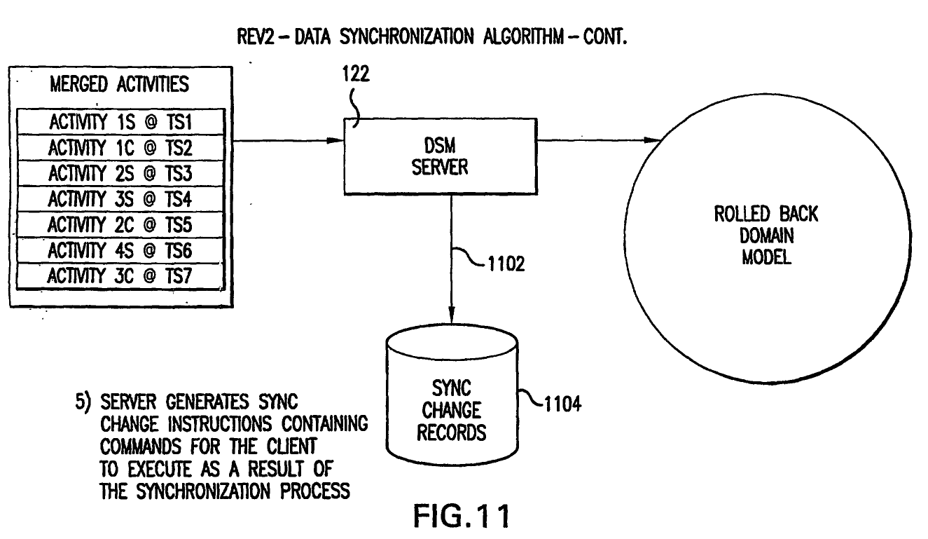

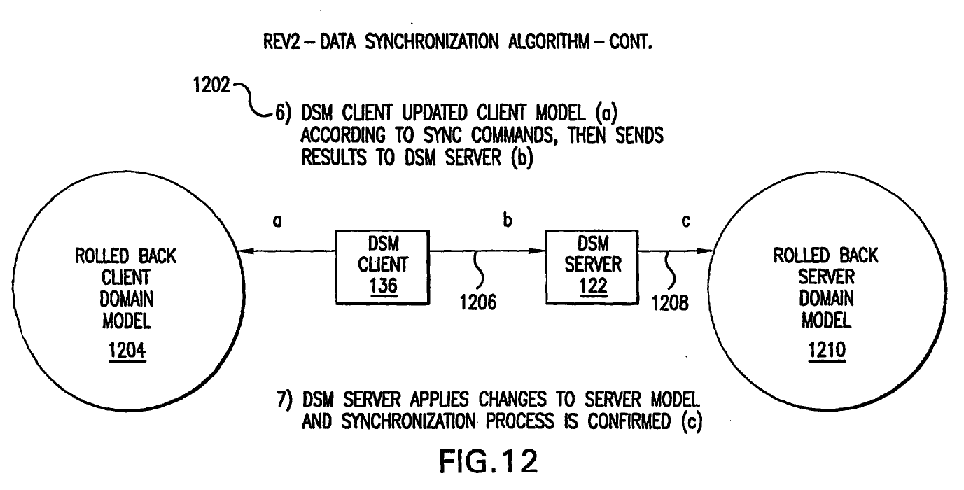

Referring to FIG. 11, the DSM server 122 will generate any synchronization change instructions for the client at step 1102. The sync change instruction can be executed by the client as a result of the synchronization process. In FIG. 12, at step 6, (1202), the DSM client 136 sends the rolled back updated client model data to the DSM server at 1206. The DSM server 122 then applies these changes at 1208 to the server domain model 1210. The synchronization process is then confirmed.

Surrogates and Simulators

The physical devices connected to the system 100 are affiliated with surrogates. The surrogacy concept is a software construct that effectively stands in place of the physical device. The software construct therefore allows complexity to be buried in the surrogate rather than the device itself. As a result of this surrogacy, many scenes can be handled effectively as a result of the surrogate's action when a “dumb” physical device would not suffice. For example, suppose a physical device is queried about its status. If there is a message pick-up so that the ultimate transmission is confusing e.g. “en route”, “arrived,” “done,” when the task is long completed, so the surrogate filters this output so that all the user sees is a “done.” Thus the surrogate device can place a software governor on the message build-up.

The surrogate device also can make choices for the physical device. For example, the system 100 can utilize multi-modal communications through the messaging/communication architectures 132, 134. When a physical device has a message, then based on its urgency as sensed by the surrogate, the surrogate can decide upon the nature of the path and optimize communications for the system 100. The surrogate also fully releases the user from the transaction. Unlike a proxy device, which works on behalf of a comparable device as a broker, the surrogate completely releases the user from a transaction altogether.

The surrogate architecture is illustrated in FIG. 26, and is described in more detail later.

It is expected that the surrogate, also known as a node governor, should be in place for all physical devices on the system.

The node governor allows throttling of multiple events issuing from the physical device (e.g., nodes 144, 146) based on a given reportingFrequency or a given reportTimer, specified in the nodeGovemor.ini.file. For instance, if a motion detector issues an event for every motion it detects, it may be beneficial to limit the number of events reported to one every 5 minutes or every hour. This allows the system 100 to not get overwhelmed with event traffic. Across powerline 142 or the wireless connection 140.

In an exemplified embodiment, there are 3 different report-throttling mechanisms that form the node governor. It is anticipated however, that any number of throttling mechanisms are usable by the present invention. All have their usages and advantages and are better suited for certain devices:

1. For example, when trying to throttle a thermostat device 144, 146, there are several settings that can be throttled—temperature, fan mode, and system mode. The user can set a reportingFrequency, for example (to be measured in milliseconds) value to throttle each of these events. A temperature event will be throttled every “n” milliseconds, for instance, and so all the other events. It should be noted that any time signature e.g. microsecond, seconds, minutes, hours, days, etc., can be used. To implement this, a proxy will maintain an internal hash table of field time stamps, which will save the time of the last event of each event type. When a new event is triggered by the device, the proxy's on VariableChanged( ) method will check its event type and look up the last time stamp in the hash table. If the time interval is less than the reporting Frequency, the event will be throttled; otherwise it is reported.

2. As an extension of the above approach, value throttling can occur where the system will examine incoming events and report only those in which the variation in value is greater than a specified value. So reporting Frequency may stand for a value increment (i.e. every 1-degree change) which can throttle events coming from devices that report a value in smaller increments, such as every 0.01 of a degree.

3. Another mechanism involves using event throttling and interpreting/dealing with hardware events according to a business-logic perspective. The WMSensor device consists of a Motion Detector and a Water Detector. When either of the alarms is triggered, the hardware flips a corresponding Boolean flag from true to false in 3 seconds' time. Since there is no such thing as a no_motion event, the system 100 has no interest in the hardware turning the motion detector off. In fact, the system needs to control the state of the motion detector. Therefore, it will only listen for true motion events, ignore false motion events and use a timer that turns the device off by itself if no more events occur. When an event reaches the proxy's on VariableChanged( ) method, the system checks the Node Model for the state of the variable changed by this event. A motion detector, for example, has a Boolean flag_motionAlarm in the NodeModel. If a motion event occurs and the Node Model's_motionAlarm is false, the system lets the event go through and update the model. In addition to that, it creates a timer to turn the _motionAlarm off. The time interval is specified in the properties file as reportTimer. If another motion event occurs while a timer is ticking, the system will throttle the event (because the NodeModel's _motionAlarm will be true) and will cancel the previous timer and create a new one based on the reportTimer value. The value can be specified in seconds, minutes, and hours. The format is, for example, [10:Second, 10:Minute, 10:Hour]. The rescheduling of the timer (which is a Schedule object) will occur for every motion event happening during a ticking timer. Once the events stop occurring and the timer expires, the schedule processor will turn the _motionAlarm off in the Proxy and Node Model.

Eventually, throttling should include preferences of application services, which may only require one motion event during a specified range of time and the rest of the events can be ignored and not reported by the proxy to the framework. There may be other application services that need to know about motion, such as the lighting service. It needs to know if someone left the room to turn off the lights, and vice versa, if someone entered the room to turn them on. In the first case, the system sets up a range of 1 minute, at the end of which if no motion was detected, the controlled lights turn off. In the second case, the system looks at the first motion event of entering the room to turn the lights on; the subsequent motion events are irrelevant. In addition, if no services subscribe to motion events, then none should be reported to the framework. The application services interested in node reports (are the subscribers for events of Node Model changes) should implement the PolicyContributorInterface where they state their desires. Both the Node Proxy and Node Model should implement the NodeEventReportingGovernorInterface. It will contain the policy the Node Model established for the device. This policy will be an aggregate of all the desires of application services (which will implement the PolicyContributorInterface).

Powerline Network Installation:

Currently, to install new devices on the Powerline network one needs to connect the PowerGate Manager to the serial port of the Client 132 and to the power line 142.

With the Node Governor, however, physical devices 144, 146 will automatically attach to the powerline 142, or to the wireless network 140 as soon as they are detected by the system 100. This will involve creating a Node Manager 2602 (a singleton OSGi utility manager) which will be listening for new unconfigured devices (OSGi service events). It will retrieve the device's VID and PIN and look for a corresponding Node Model in the framework. If a match is found, it will try to install the device. This will involve retrieving the current network tree from the hardware and attaching the device to the right sub-network manager. Because this will take place behind the scenes, it will simplify the installation process in the user's home. In the preferred embodiment the following device simulators are included:

Simulated Devices:

1. SimThermostat

2. SimPowerswitch

3. SimPowerSwitchA (submeter)

4. SimWaterDetector

5. SimMotionDetector

6. SimTwoButtonLightSwitch

7. SimDimmerLightSwitch

In an effort to allow for volume testing of hardware interacting with the system 100 framework, a simulated user can change the state of any device in his home at a specified time or frequency as specified by the Tick, Daily, Weekly, Monthly or Non-periodical schedules. This saves time targeting each device manually. The states of many devices can be changed at the same time in order to test the system 100 response to multiple events flooding the system 100. Below are examples of several simulated devices:

1. SimThermostat:
A SimThermostat device is implemented to mimic the Honeywell T8635L thermostat with scheduling capability. The Honeywell thermostat has four program periods (Wake, Leave, Return, Sleep) that can be programmed to change the heat set-point, the cool set-point and the fan settings. These program periods have start times only and it is assumed that when the start time of one period begins the period that was operating before it ends. Operation is based on a Daily or a Weekly mode. The simulated thermostat emulates this functionality by using the ASA Scheduler module, which nudges it to wake up at the start of each program period and execute the specified changes on the state of the device.

2. SimPowerSwitch
Simulates a simple on/off power switch.

3. SimPowerswitchA
Simulates a power switch with sub-metering and load shedding. It has voltage, current, frequency, power factor, power demand, cumulative power demand and peak power demand.

4. SimWaterDetector
Simulates a water detector with a Boolean variable _waterAlarm, which describes the state of the device.

5. SimMotionDetector
Simulates a motion detector with a Boolean variable motionAlarm, which describes the state of the device.

6. SimTwoButtonLightSwitch
Simulates a controllable 2-button light switch device. Can be turned on/off at the device level or through the Node Model.

7. SimDimmerLightSwitch
Simulates a controllable dimmer light switch device. It extends the functionality of the 2-button light switch and also has the option of setting the dimmer speed and intensity of the light.

Existing Application Services:

1. ApplianceMonitoringAndControlService

2. FloodDetectionService

3. LightingControlService

4. TemperatureControlService

5. TemperatureMonitoringService

6. MotionMonitoringService

7. SmokeDetectionService

1. ApplianceMonitoringandControlService

ApplianceMonitoringAndControlController:

Fully extends the functionality of the ApplicationServiceController.

ApplianceMonitoringAndControlEventProcessor:

The event processor gets invoked when an ASA Event is sent to it from the framework. If the source of the event implements the PowerSwitchInterface then a history entry is created based on the new state of the power switch device (on/off).

ApplianceMonitoringAndControlScheduleProcessor:

Fully extends the functionality of the Application-ServiceScheduleProcessor.

ApplianceMonitoringAndControlService:

The service specifies the possible commands it can accept: powerOn and powerOff. These methods target the Node Model. Also, it has methods that retrieve history entries of “powered on” and “powered off.” Most of the functionality is in its super class: ApplicationService.

ApplianceMonitoringAndControlGUI:

The graphic user interface (“GUI”) displays associated and non-associated power switch devices. For associated devices, a user can switch the Power State on and off, override and resume hardware schedules, get history, and create and review schedules. The system framework allows creating a scheduling capability for any controllable device that is not designed to have scheduling. Scheduling uses Schedule objects and the Scheduler. Schedules can be Tick, Daily, Weekly, Monthly, Yearly and Non-periodical. In addition, the ApplianceMonitoringAndControl service allows for rules to be set up that specify what is to be done when alerts from these application services are received by ApplianceMonitoringAndControl service.

FloodDetectionGui:

The GUI allows the user to view the status of the flood detectors (alarming or not alarming), activate/deactivate them, obtain history of water alarms and set time to notify about repeating service alerts from the application service standpoint.

LightingControlService:

Defines possible commands to be turnOn, turnoff, setDimmerIntensity, and setDimmerSpeed. Supports both a 2-Button light switch and a dimmer light switch type. setDimmerIntensity and setDimmerSpeed methods are only defined for the dimmer light switch. turnOn and turnoff are defined for both because type DimmerLightSwitch is a child of TwoButtonLightSwitch.

TemperatureControlGui:

Allows the user to view the associated thermostat devices, see their current heating and cooling set points, change them and create schedules based on Honeywell format and pushes them to the Node Model via APF. It is expected that the simulator can be modified to mimic any model of thermostat. The Node Model pushes them to the Node Proxy, which in turn submits them to the device for processing. Since the schedules are made according to the Honeywell scheduling format, the device treats them as though the user manually entered those schedules through interaction with the device.

TemperatureMonitoringController:

Creates/modifies service alert descriptions, post-associates a node where a temperature threshold is created for the TemperatureMonitoringService, post-disassociates a node, which among other functions, removes the temperature threshold for the node. Also, the value of the temperature of a particular thermostat node is validated. If the temperature is below a Low threshold or above a High threshold, a service alert thread is created to notify that the temperature has exceeded a given threshold level. If, however, the temperature falls between the Low and High thresholds, no alert is sent out and an alert thread is killed.

TemperatureMonitoringEventProcessor:

The processEvent method receives an ASAEvent, checks its source to make sure it only reacts to events coming from a thermostat device and if the eventType is “setModelTemperature”, it issues an APF call to create a history entry and calls validateTemperature to dispatch service alerts if necessary.

TemperatureMonitoringService:

Sets up possible commands to be setHighThreshold and setLowThreshold. These thresholds allow the user to customize the bounds outside which he will receive alert notification of a temperature breach. The primary function of this is to check whether the air conditioning and/or heating systems are functioning properly. For example, suppose the thermostat (which controls both the A/C and heater in residential homes) has a heating set point of 50 and a cooling set point of 80. The user has also set up a lowThreshold of 40 and a highThreshold of 90. Suddenly, the temperature starts dropping below 5 and continues to drop below 40. This indicates that the heating system failed to activate to bring the temperature back up. An alert would be sent out to the user indicating that a breach of the lowThreshold has been made. Likewise, if a temperature rises above 90 degrees that would indicate that the air conditioning system is malfunctioning. This is also useful if a user wants to know that his vacation home is getting very cold and unless he turns on the heat, the water in the pipes will burst, etc. Or, if the temperature in the home suddenly gets very hot, there may be a fire.

In addition, the service has methods to add/remove thresholds and update all thresholds by an outside source.

TemperatureThreshold:

This class is a container of the low and high threshold values that can be set and retrieved. Each instance is associated to a nodeId and a TemperatureMonitoring Service.

TemperatureMonitoringGui

The GUI class displays associated and non-associated thermostat devices. For associated devices, the current high and low thresholds are shown in textfields and can be modified by changing the value in the textfields and pressing the Set Criteria button. The heating set point, cooling set point and current temperature are also shown. A user can also modify the time to notify (frequency) about repeating events and view history for a particular device.

MotionMonitoringService

The MotionMonitoringService listens for motion events coming from devices and dispatches appropriate service alerts to other services in the framework. The MotionMonitoringRanges allow the system to detect motion or the absence of motion during a specific time range. This is a useful feature in that it allows a user to customize alerts that he receives. Such a range is based on a 24 hour clock and operates in Daily or Weekly schedule modes.

Mode_Motion looks for any possible motion events to occur during the specified range. If a motion does not occur, the system does not do anything about it, and it is deemed a normal outcome. Only when motion occurs does the system send out an event.

Mode_No_Motion looks for no motion to occur. This also implies that having motion is normal; however, not having it is the cause for an event dispatch.

If the mode of the range is set to Mode_No_Motion, at the end of the Range, a check will be made to see if no motion was detected and if true, an alert would go out to the user and a history entry will be created. The MotionMonitoringScheduleProcessor handles this check. The MotionMonitoringRange object consists of two Schedule objects—one for start of range and one for end of range. The schedules can be Daily or Weekly, but always consistent in terms of type. Such an alert could be useful, if for instance, a user has old parents home alone during the day and he wants to monitor the motion in the home. If the motion suddenly disappears, it may be cause for alarm (someone may have become ill) and the user is notified. Likewise, if schoolchildren are supposed to be home by a certain hour in the afternoon, but the lack of motion during a specified range suggests that they are not there, a user would be notified.

In the case of a range set to Motion mode, if a motion event comes, it is handled by MotionMonitoringEventProcessor, which checks whether this motion event falls into any of the existing ranges. If true, it dispatches a ServiceMotionAlert and a MotionAlert pass-through for other application services. If a motion event falls outside of any range, only the MotionAlert is dispatched.

MotionMonitoringController:

Incorporating some of the business logic, this component interfaces with the function layer. After a node model is created, a postAssociate Node gets called to perform a final association of the node and create the MotionMonitoringRangeContainer, which contains MotionMonitoringRanges for this device. The postDisassociateNode method is called upon removal of a node model. MotionMonitoringRanges are added to/removed from the MotionMonitoringService. The method calls are initiated by the MotionMonitoringGUI. If the scheduleType for the Range is activated, we add the Range's schedules to the ScheduleAgent so it will wake them up when they are about to start. Otherwise, ranges are deactivated. Creates/modifies Service AlertDescriptions, which explain what each of the alerts means. GenerateMotionAlert creates alerts that are passed through to other application services over the “motion” channel. GenerateServiceMotionAlert creates alerts targeting the services subscribed to “service.alert” channel. The GenerateSerivceNoMotionAlert also targets the “service.alert” channel.

MotionMonitoringEventProcessor:

This component is responsible for processing motion events arriving from the framework. A device sends out an event when it detects motion; this updates the Node Proxy, which updates the framework. The framework reports this change to the Node Model and sends out ADA Events to all interested parties such as the Application Services. When this event processor gets a motion event, it determines the source of the event (i.e., the Node Model that sent it) and using it uniqueID can retrieve its MotionMonitoringRangeContainer and search through its MotionMonitoringRanges to check if the current event falls into any range. If it does not fall into any range, only a history category is created and MotionMonitoringController's genrateMotionAlert is called to create a pass-through motion alert for other services. If the event does fall in between a range, the system invokes the APF to change the state of the selected MotionMonitoringRange object to indicate that motion is detected within its range. Also, if the range's mode was set to Mode_Motion, the system 100 invokes the generateServiceMotionAlert of the MotionMonitoringController component. Lastly, the system creates a history entry and a pass-through motion alert as in the case above.

MotionMonitoringRange:

This component is a logical representation of a time interval with a start time and an end time. It is implemented with 2 Schedule objects—one for start and one for end, respectively. The scheduleType/rangeType can be either daily or weekly and is based on a 24-hour clock. For weekly schedules, both start and end times must begin and end on the same day, and if the end time is past midnight, it is assumed to end the next day. So, for instance, a Weekly range starting on Monday at 10 pm and ending at 3 am—is translated as ending on Tuesday morning. The underlying schedules share the same rangeStatus—activated/deactivated and same scheduleType: daily/weekly. The MotionMonitoringRange has a Boolean flag ‘motionDetected’, which is checked at the end of the Range to determine whether motion was detected. The method setMotionDetected is called by the MotionMonitoringScheduleProcessor via APF to clear the flag at the start schedule and by the MotionMonitoringEventProcessor via APF when a motion event occurs. The MotionMonitoringRange also has a method, which tests whether it surrounds a range supplied as an argument.

MotionMonitoringRangeContainer:

Each device has an instance of this component, which keeps a vector of ranges for that device. It has basic get and set methods for adding/removing ranges, setting up/removing the associated MotionMonitoringService.

MotionMonitoringScheduleProcessor:

This component gets created by reflection in the Scheduler (in the WakeUpTask:run( )method) when the Schedule component of a Range object is woken up. Note that due to the algorithm implemented by the Scheduler, the moment a schedule is woken up, its wake-up time is immediately rescheduled for the future. Therefore, after the schedule has woken up, you cannot find out when it did actually wake by trying to call aSchedule.getDate( ) or a.Schedule.getCalendar( ). To get the actual time, you need to subtract the time interval from the current time to get the old time. In other words, if schedule type was weekly, you can call schedule.getCalendar( ).add(Calendar.WEEK_OF_MONTH, −1) and it will get you the recent wake-up time.

If the Schedule object represents the start of the Range, then the system 100 calls APF to clear the Boolean flag ‘motionDetected’ in the Range object. If the object is the end of the Range, the system retrieves the flag ‘motionDetected’ from the Range and checks whether the mode of the Range is Mode_No_Motion. If no motion is detected and the Mode is Mode_No_Motion, the system generates a ServiceNoMotionAlert and creates a history entry.

MotionMonitoringService:

This component contains a hashtable of all MotionMonitoringRangeContainers for all motion detectors present in the system. Based on a uniqueID, it can retrieve its corresponding container, which will contain MotionMonitoringRanges for that particular device. A user can add/remove MotionMonitoringRangeContainers, add/remove MotionMonitoringRanges and activate/deactivate the motion detector Node Model.

MotionMonitoringGUI:

This java servlet acts as an entry point to the MotionMonitoringService on the server side. The user can activate/deactivate the Motion Detector Node Model, add/remove a Range and activate/deactivate a Range.

Scenes

The Home Intelligence System 100 of the present invention allows for control and customization of operation of nodes 144, 146 in the house 160. As previously discussed, a node is defined as an electronic device able to monitor and/or control a surrounding environment. Examples of nodes include thermostats, electrical ON/OFF switches, gas/water detectors and so on.

The house 160 can be subdivided into locations, which are defined to be logical collections of nodes 144, 146 grouped by their proximity to each other in a particular home space, such as a room, a floor or other part of a house. Locations are defined and maintained by users and can represent an entire house 160 or any subsection of it. For example, Master Bedroom, Dining Room, Living Room, Basement are all locations within the house.

A scene is a collection of nodes in a desired state. This state is going to persist for the duration of the scene. Scenes in common parlance, are easy to say, but hard to do. For example, it is easy to say a “party” scene, but that may involve an elaborate arrangement of nodal settings. The notion of a scene also requires definitional discipline. It requires that the system 100 make consistent statements for many very diverse nodal settings to fulfill the user's needs. Another example is a combination of the following node states which can constitute a scene:

| | |
|---|---|
| Kitchen light | OFF |
| Living room 2-button light switch | ON |
| Thermostat heating point: | 66 degrees Fahrenheit |
| Dining room chandelier | Intensity = 75 |
| Kitchen coffee pot | OFF |
| Refrigerator | ON |
| Bedroom 1 TV | ON |
| Bedroom 4 VideoGame Console | OFF |

Scenes are divided into two categories: supplied by the System 100 and defined by User at the client device 138. For example, in a preferred embodiment there are five System supplied scenes:

“Asleep”

“Awake”

“Away”

“Home Night”

“Home”

The user can determine whether a scene has a schedule or not. The user can also change an existing schedule for a given scene. If the scheduling option is disabled, the user can manually turn on system scenes when desired. Otherwise, with automatic scheduling enabled, the system 100 goes through each scene once during the day. The scenes operate based on a 24 hour system clock. By default, each scene has a start time only, since they are continuous in time, the start of one scene implies the end of the previous scene. In the preferred embodiment, only one system supplied scene can be active at any one time and at any time, one of the system scenes. The custom scenes can have start/end times, and can repeat as many times a day as desired. Custom scenes can occur at the same time as other custom scenes. The custom scenes are not exclusive of each other as are system scenes. The following is an example of a custom scene:

### Kids Play Time Scene

| | |
|---|---|
| Living Room Dimmer | Intensity = 100 |
| Living Room TV | ON |
| Bedroom 2 Stereo | ON |
| Bedroom 2 Lamp | ON |
| Bedroom 4 Video Game Console | ON |

Scenes can be activated/started and de-activated/ended automatically (through a schedule) or manually. Also, system and custom scenes can be activated subject to motion being detected within a specified range. A user needs to specify which motion detector should be associated with this operation and a time interval. If motion is detected within this time interval, the specified scene will become the active scene. Custom scenes can be deactivated subject to “No Motion” detected within a specified range. The user must select the desired motion detector and enter the time in minutes after which the selected custom scene will be deactivated if no motion is detected within the time interval. If motion does happen before the timer on this schedule expires, then the timer is rescheduled for the same time interval into the future. This process will continue as long as motion is being detected. Once motion stops and the timer has a chance to run out, then the scene will be deactivated.

Scenes can control as many or as few of the home's nodes 144, 146 around the house 160 regardless of their location.

For scenes that are scheduled (scheduled start and/or end time), the schedule applies to the entire scene. The user does not have the ability to apply different schedules to different nodes within a scene.

In the preferred embodiment, when a custom scene is activated (e.g., “cooking scene”), settings for the selected custom scene nodes will override those settings for the same nodes in any active System scene (e.g. “Home” scene). When a custom scene ends, the node settings will return to the state dictated by the active System supplied scene, unless the custom scene was ended as a result of another custom scene taking its place in which case the node settings will be dictated by the new custom scene.

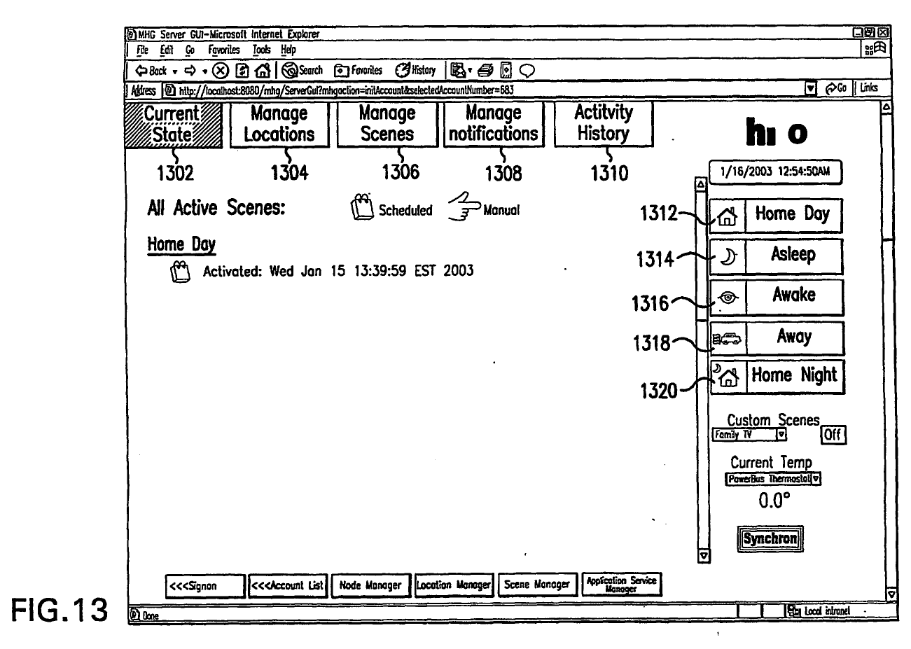

FIG. 13 illustrates the user interface (“UI”) that is connected to the residential gateway 138 (FIG. 1). It should be noted that the UI can be displayed in any number of known or conventional interfaces, e.g. PDA, website, pager, TV-set, thermostat, etc. As illustrated, the UI includes five tabs located along the top navigation bar: current state 1302, manage locations 1304, manage scenes 1306, manage notifications 1308 and activity history 1310. Upon activation of the current state 1302 the currently active state 1312 is indicated. The details concerning the active scene are shown, e.g., “home day—scheduled, activated: Wed Jan 15 13:39:59 EST 2003.” Additionally, the scene button 1312 is lighted to indicate it is the current state.

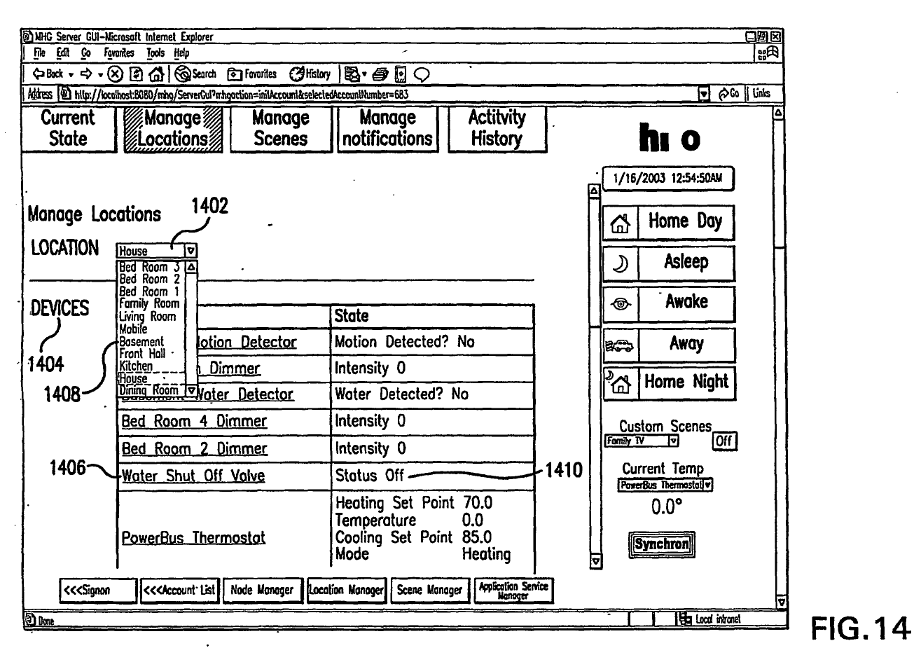

FIG. 14 shows the manage locations tab 1304. When this tab is activated, the devices for each chosen location are shown. In the example shown in FIG. 14, the entire house 1402 location is selected. A sizable number of devices 1404 are shown along with their current state. In the manage location, different sensors can be grouped to a chosen location. Therefore, the water shut-off valve 1406 can be moved to the basement location 148, and can be turned “on” in the state entry 1410.

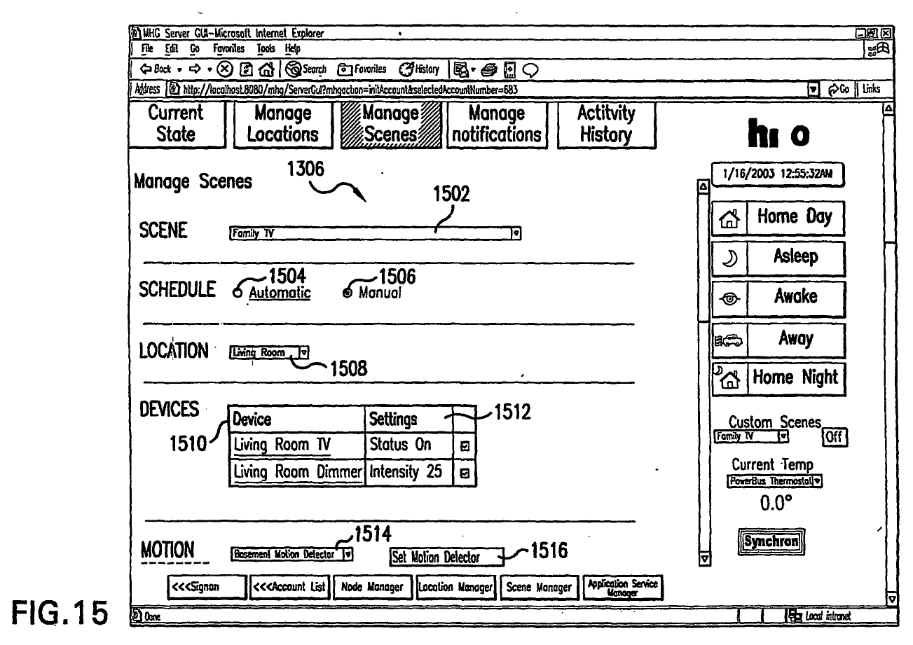

FIG. 15 illustrates the manage scenes function 1306. As illustrated, the available scenes are provided on a drop down list 1502. The user can then choose to schedule the selected scene automatically 1504 or as a manual option 1506. The scene can also be targeted to a desired location via drop down list 1508. Devices 1510 and the device settings 1512 can then be selected by the user. Finally, motion detectors can be selected from the drop down list 1514 and activated at 1516.

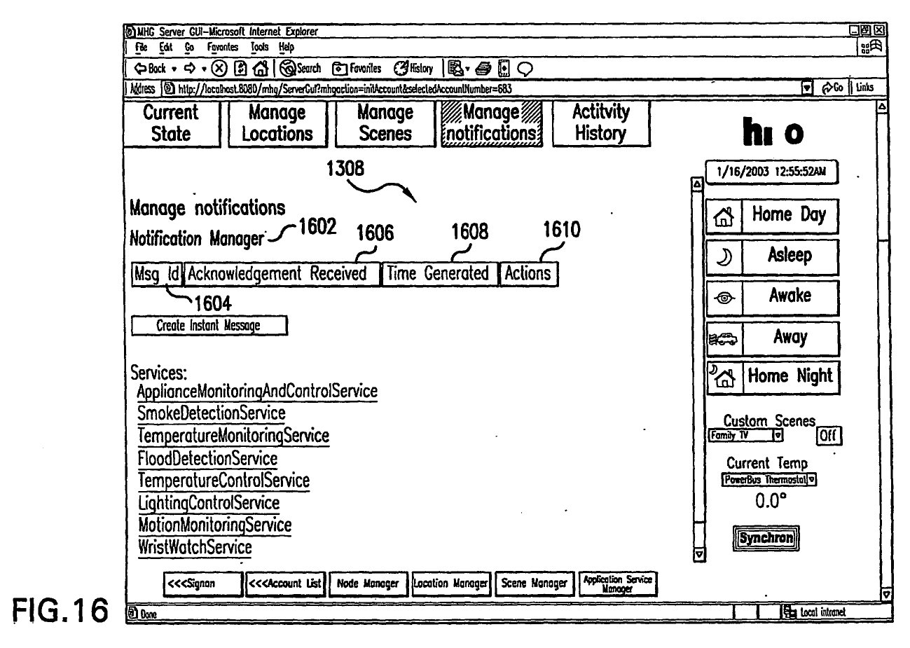

The manage notifications tab 1308 create the notification rules for each service and lists notifications received from system nodes. FIG. 16 illustrates the format for incoming messages 1602, each of which include a message id 1604, an acknowledgment received button 1606, a generated time button 1608 and an action block 1610.

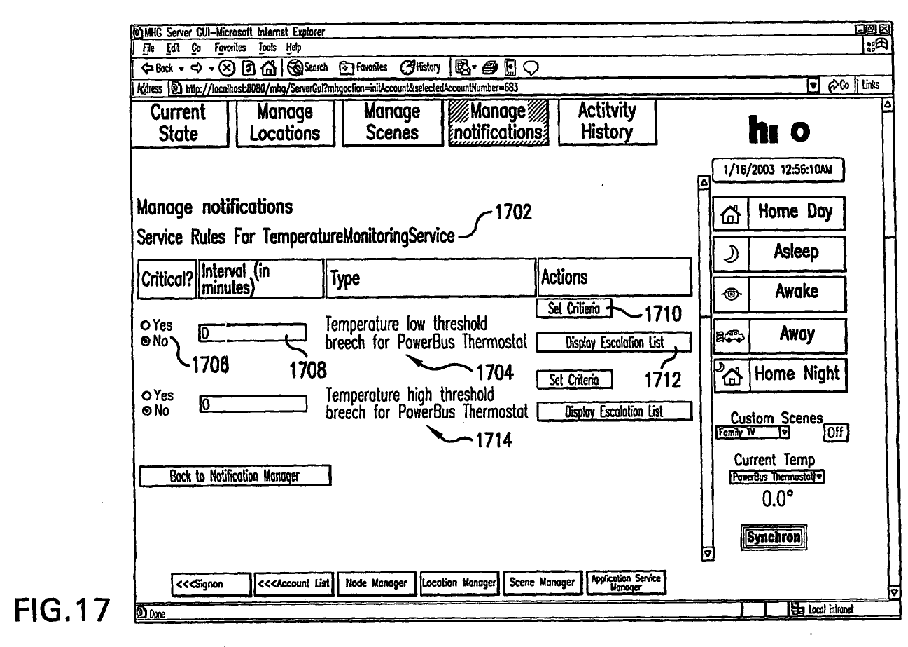

FIG. 17 shows the service rules for notifications for the Temperature Monitoring Service 1702. Four rules are identified for a device low 1704 and a device high 1714 setting. For the low settings, the system queries the criticality of the notice 1706, the notification time intervals in minutes 1708, the set criteria 1710 and display escalation list 1712. Once these settings are created, the system can return back to the main notification tab.

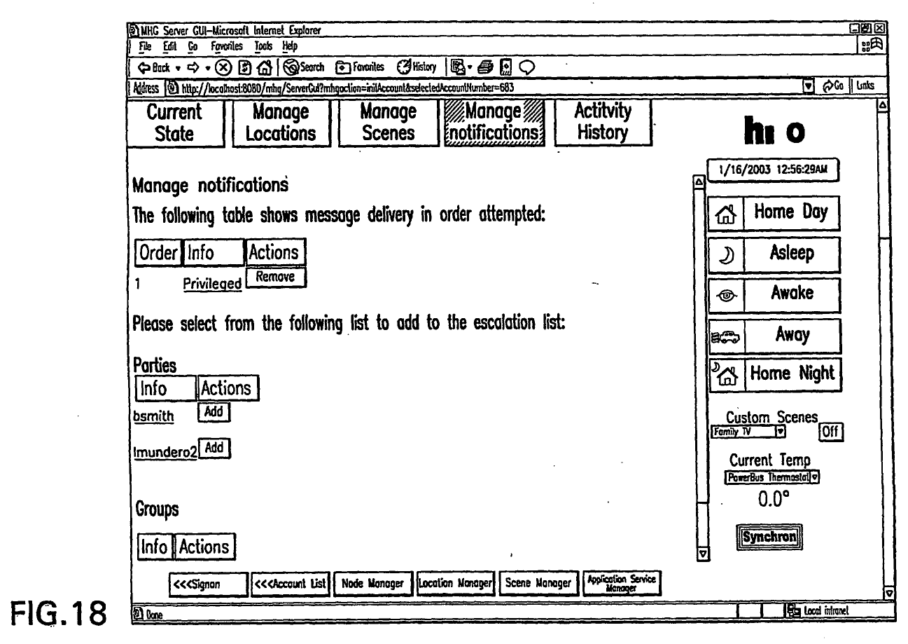

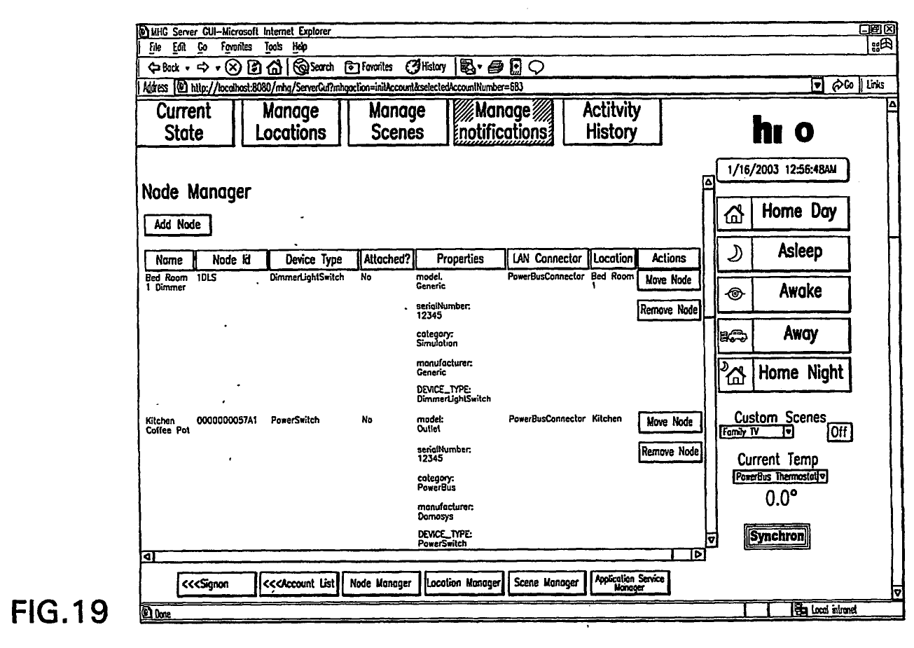

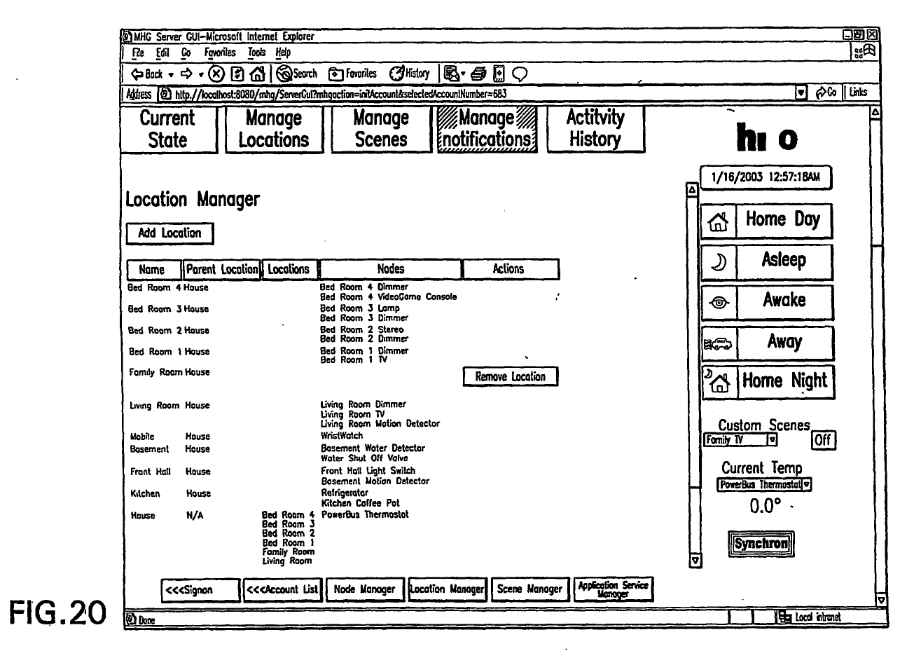

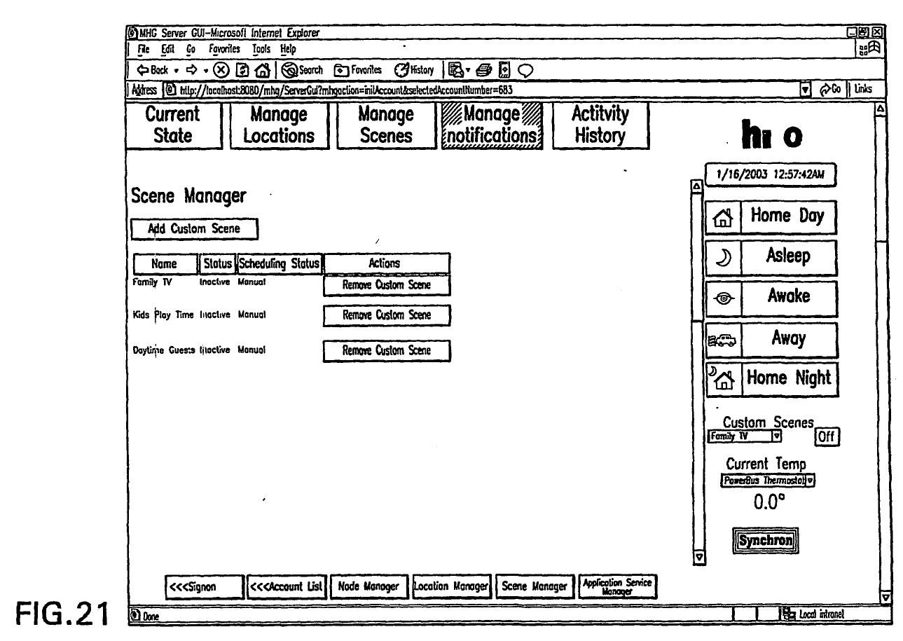

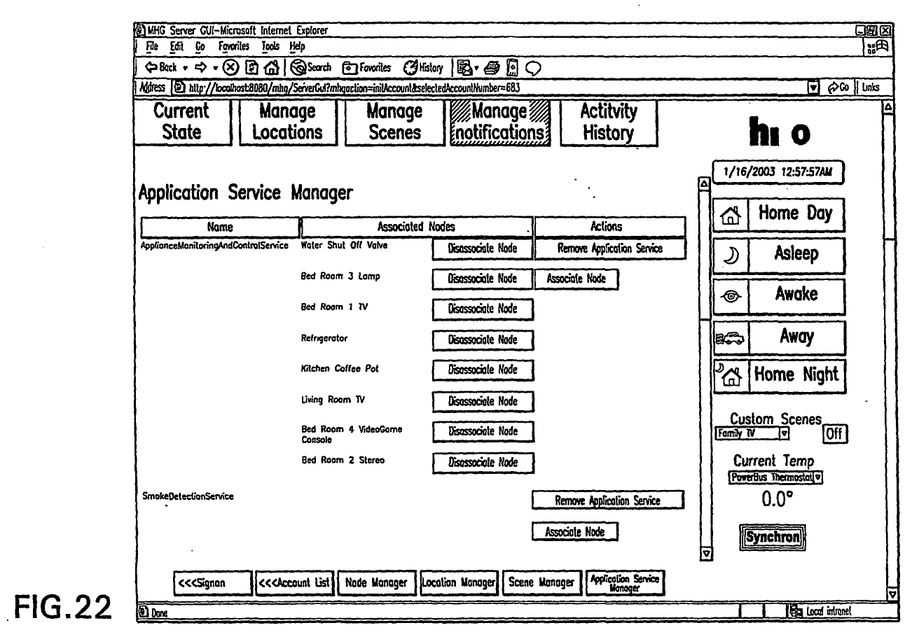

FIGS. 18 and 19 respectively show the messages delivery and the node manager elements of the manage notifications tab. FIGS. 20 and 21 illustrate the location manager and the scene manager options for the manage notifications tab. FIG. 22 illustrates the application services manager of the manage notification tab.

As shown in FIG. 26, the reason a governor is employed is that the physical nodes that are in the home 160, e.g., your thermostat, heating equipment, motion sensors have state information to announce to system 100. For instance, the temperature has changed and there is detected motion in the house. The system has a model that exists both on the client 138 inside the home that is a virtual representation of those physical nodes 144, 146. The model exists on the server side 138 so that a user can almost talk to a node 144, 146 even though they are not physically present on the server side 102. The difference is that the physical node does not actually have to be present in order to talk to the virtual node 2604. As a result, there is brokering between the virtual node and the physical node in the home 160 so that as changes are coming from the server side, or the client side server connected to the virtual node through 2610. The virtual node accepts and coordinates with the physical nodes to tell, for example, the thermostat to update its temperature and, on the other side, report that the temperature has changed. The virtual node 2604 is also responsible for notifying other components in the system that the temperature has changed.

The node governor 2612 comes into play in that there is a potential for a huge amount of traffic to be coming in and to be reported to the virtual node 2604 by the physical nodes 144, 146. The problem is that all of the information that is coming in may not be relevant to the processing of the system 100. So, the node governor 2612 applies rules provided along line 2610 to determine when an event coming from the physical nodes 144, 146 is applicable to functionality in the system 100. Thus, instead of a motion sensor telling the virtual motion sensor “I detect a motion” every second, the node governor filters traffic and only accepts inputs based on when they are deemed relevant to functionality in the system. That determination rule may be based on services that are employing the virtual node. For instance a motion-monitoring service may say “I want notification when I detect motion between these hours” and that is the only relevant piece of information received from the physical node. Therefore, the node governor 2612 insures that the virtual node 2604 only receives that input from the physical device 144, 146 in order to facilitate that functionality in the system 100. As a result, the node governor 2612 can shut down all other alerts of state changes and prevent them from coming into the system 100 along line 2610 so that either the client side server or the server side server are not flooded with alarms from all of the physical nodes 144, 146.

This implementation therefore provides two levels of sophistication. One is a static rule-based approach where the node governor 2612 is based on a physical node 144, 146 that reports the frequency in which you should accept reported state changes. The next level is that the system 100 is like an economic system where the value of that alert that's coming into the system is based on the demand along line 2610 to the system 100 for hearing about a report. So if three services were very interested in the fire alarm output and that were deemed high priority, then the fire alarm reports from the node governor 2612 would alter itself in order that those are critical. The traffic of the alarms can thus be throttled by the governor by the importance of the demand for those alarms.

Beyond the governor, nodal simulation is important. It is critical to simulate the volumes of nodes that are in one home without having to physically install those nodes. The system is designed so that the physical nodes 144, 146 communicate with the virtual nodes 2604 as their virtual representatives; this can be scaled so that the system 100 can simulate multiple virtual test homes so that the communication between all of those “virtual” homes 160 and server 102 can be simulated in software without having to install a thousand test homes and all of the respective nodes. This is accomplished by building node simulators as part of the virtual nodes 2604 that bind to the virtual nodes just the same way a physical node would be bound.

The system further includes a scheduling engine 2620 that splits simulated behavior of the physical nodes 144, 146 so that it can generate some alarms (simulated or real) by raising the temperature, some by the temperature changing, some by the fire alarm going off. Thus, any type of interaction that would be coming from physical nodes the system can script its behavior in this simulated mode, using a combination of the scheduling engine 2620 and the virtual node 2604.

The system further includes a node manager 2602 that brokers the communication between the virtual nodes 2604 and the physical nodes 144, 146, through the communications means 140 and 142.

Referring to FIG. 23, the state based conflict management architecture is illustrated. The notion shown in FIG. 23 is that the way the synchronization works is that when changes happen on both the client 138 and the server 102, there is an implicit broken connection between the two. Thus, state changes that happen are applied to either side as time goes on without any regard to what is happening on the other side (server, client). For example, a user is on the phone and maybe the only communication channel between the server 102 and the client 138 is a shared line within the house 160. Since a user is on the phone, the client cannot connect to the server 102. While the system is not in communication, someone at the home 160 is turning on lights, turning off lights, raising the thermostat, etc. As a result, events occur when there is no communication between the client 138 and the server 102 because when somebody interacts with system 100 in the home 160, he/she needs to be able to go to the system 100 (e.g., through the in-home UI) and command “turn on my lights.” The system 100 cannot respond by indicating that it cannot accomplish this objective since it cannot communicate with the server 102. As a result, state changes must occur regardless of whether or not communication exists with the server 102 or the client 138.

A problem occurs when there are requests coming from both the client 138 and server 102 sides, with no working connection therebetween. For example, if a customer is located remotely and through his cell phone indicates “load the thermostat because I left and I don't want the heat running all day.” The customer does not know that his wife came home for the day because she wasn't feeling well. She said “raise the thermostat” because it is too cold. Since there is no connection, those comments are applied by the client 138 or by the server 102. But now what happens is a connection is established and those transactions that have happened since the last synchronization need to be reconciled. Transactions coming from the server 102 where the remote customer was commanding to lower the thermostat and that transaction from the client server 138 that commands “raise the thermostat” are presented. A conflict manager 2304 therefore is required to deal with conflict situations such as these.

The manager 2304 then resolves the conflicts while the spec manager 2302 applies the system rules.

The conflict system 2300 is a rules-based system that it is configurable by a system designer and by the system user. Rules can be extended at any time to a configuration based primarily on user-provided preferences. As a result, conflicts in the system rely on a flexible rules-based engine that can take input from either system “defaults” or user preferences or even state-conditions that are happening to the environment. These rules are presented as specifications through any form of external input 2340 to the DSM conflict SpecManager 2302

Criteria 2312 is used to filter the system provided activities 2306, 2308. When the system 100 looks at whether conflicts exist, it analyzes those activities that are coming in from the server 102, and the client 138. The system qualifies or narrows the server activities 2308 against the client activities 2306 to determine whether a potential conflict exists. Whatever the server activity and the client activity criteria are, they are applied against the set of server activities. Client activity criterias apply against the client activities. What results is a subset of all the activities that have happened. When the system evaluates the criteria, both sets (client and server) are empty or if any one of the sets are empty, then there are no potential conflicts and the system shall accept all the transactions that have happened. If both sets have narrowed activities, then the system goes to the next level. The first level is function-related. A functional level means the following: if a user turns on a light and turns off a light those are deemed functionally equivalent. The system needs however to then determine if it is the same exact light the user was operating at both points. So, functionally, the user operated on a light. But now the system needs to go to the next level to conclude that it is the same light that the user was operating on since the user could have twenty lights wired up in his/her house 160. The match criteria 2320 therefore looks at the qualified set of server and client activities 2322 to determine if there are any matches between the two from a functional standpoint. If there are matches, then that is deemed a conflict in which case the system client 138 or server modifies 102 these actions through the DSM Conflict Manager 2304 depending on who is setting the rules. The system therefore looks at the client actions to see what to do with those activities. Specifically, it looks at both the server and the client actions and applies them to the sets that relate to either the client or the server. Those actions could either be applied which means to just “accept” the activity. It will then get applied locally. The activity conflict could cause a roll back in the domain model. Once applied the system 100 deletes the activity. The reason the system must do that is because even though two activities are functional equivalents—in other words, the transaction has happened on the client and the server activity is in conflict, the problem is that the changes that are represented by that server activity may be a super set of the client changes that have happened in the client activity. So it is not enough to just say “apply/define” transactions. The client has to indicate a roll-back to its existing activity before it is applied or defined.

The attribute names 2324 and the values that go with those criterias are used to determine where the conflicts are and whether there are matches. The activity has properties on it which explain what changes have occurred as a result of that activity. For example, a light switch called—“bedroom light switch” was turned on at the state is equal to an “on” state or change. The properties are different based on what the function is that actually generated the state, but the properties of the activities are data elements that are used to determine the matching of conflicts. Several things therefore must be considered in matching. One is the actual properties or actual attributes that the developer added to that activity. Two is the time it was created. A user could actually send messages to objects that exist in the system 100 at the time that he/she was doing the evaluation of the matching. So a user might want to check the current state of the light switch to consider in his/her conflict management. Three is a property or data element or some attribute of the activity itself which indicates what function it was and who created this function (because part of the conflict management is a decision of a user's actions based on the conflict management).

With regard to element conflicts manager manager 2324 (“CMM”), the system 138 only needs one conflict manager 2304 because it represents one house 160. There can however be many homes connected to the server 102 that need to synchronize. There must be a way to register all of the synchronization processes that are happening on the server side.

There are also events that need to be triggered based on the completion of synchronization: UIs are updated, notifications are sent The synchronization CMM 2324 is responsible for managing the life cycle of all of the synchronization managers connected to the system 100. Also, there could be problems with the synchronization process, which can in turn be monitored by the CMM 2324.

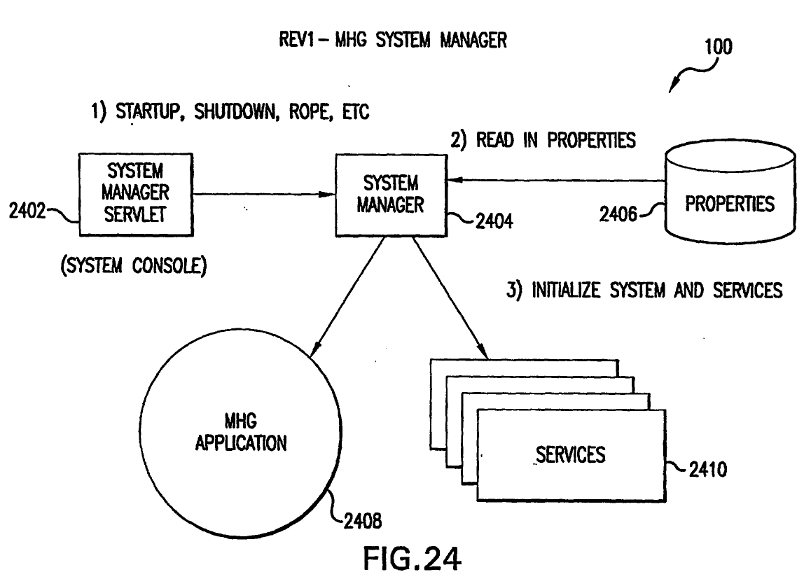

Referring to FIG. 24, the system manager architecture is shown. By way of background there are common reusable application services that are available off the shelf. For example, there is J2EE which is Java infrastructure, which provides common reusable functions, like section management, transaction management, error handling. On the client side 138 of the system 100, however, there are no off-the-shelf architectures that support applications. Moreover, the client side 138 needs to stand by itself as a peer of the server 102. There is therefore a need to build common, reusable application functions and application services that any application would use.

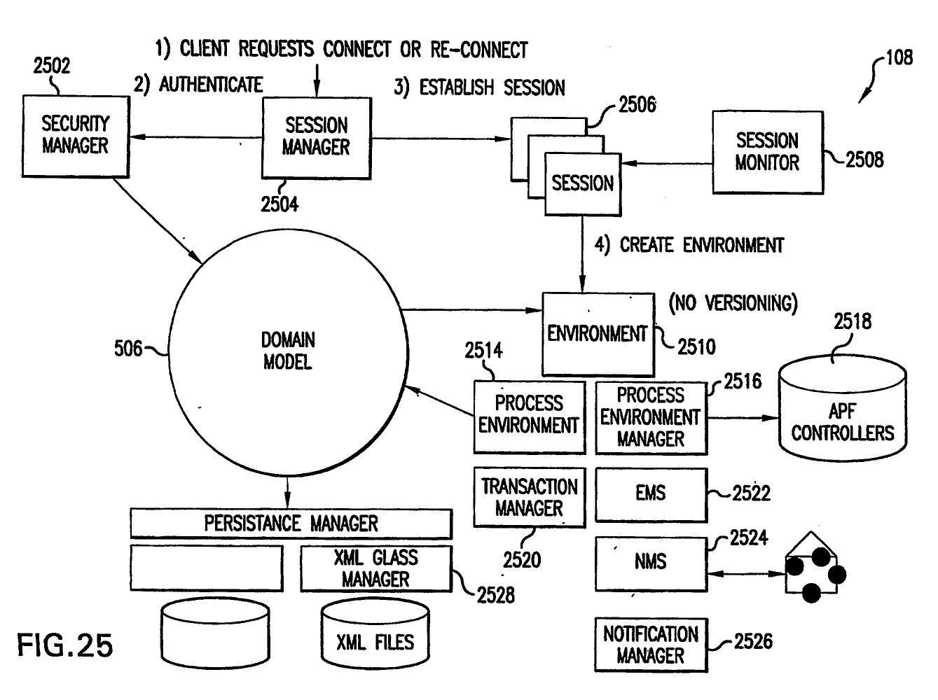

The architectures shown on FIGS. 24-25 are symmetrical peers, in other words the same architecture. They run the same application components. The only difference between the client and server architectures is that they use different types of databases. One uses a Java-embedded database, called HSQL. The server architecture uses Oracle.

Referring to FIG. 24, a manager 2404 is responsible for people connecting to the system 100 and creating a session. The manager 2404 also fields requests and deals with errors as they happen on the system 100. The manager therefore is responsible for tying things together.

There also are services 2410 that get plugged into the system manager. As applications 2408 get installed, the system manager 2404 configures them and affiliated services get initialized. Services 2410 are initialized from a configuration file called “properties” 2406. Additionally, the architecture includes a console graphic user interface (manager servlet) 2402 that allows the client to manipulate the system manager, the installed services, and the applications 2408 after start-up.

With respect to FIG. 25, the client architectural elements, and logical flow between those elements is shown.

The session manager 2504 receives client requests to connect or re-connect to the device and authenticate the user. To properly authenticate a user, a specialized manager called the security manager 2502 is accessed by the session manager 2504. The security manager 2502 is responsible for keeping user information and access level control data that determines who can have access to system 100.

If the user is authenticated, then the session manager 2504 establishes a session 2506 for the end user. By establishing a session 2506, a function scratch pad as previously described is formed. Once the session is established, the architecture creates an environment 2510 which is related to the application process framework 2518.

An environment 2510 is the system's scratch pad where data relevant to functions is used to call functions in the workbench. Moreover, process environment manager 2516 gets initialized with the file that contains the APF controllers 2518 specified in the workbench. The EMS 2522, NMS 2824 and notification manager are all initialized with the created environment.

The persistence manager is used to abstract the HSQL database on the client side and an Oracle database on the server side (in the form of a persistence manager layer) so that the system 100 operates identically on both sides but uses two different databases to do so. As a result the persistence manager abstracts out the physical database for use by the domain model 506.

In the drawings and specification, there have been disclosed typical preferred embodiments of the invention and, although specific terms are employed, they are used in a generic and descriptive sense only and not for purposes of limitation, the scope of the invention being set forth in the following claims.

1. A home control system comprising:
a central server;
a client server located in a home;
a plurality of home nodes connected to the client server;
a conflicts manager for receiving inputs from said central server and said client server; and
a conflicts specification manager for receiving specifications describing how to resolve conflicts between said central server and said client server; wherein said conflicts manager applies said specifications in order to resolve conflicts based on said central server inputs and said client server inputs.

2. The home control system of claim 1, wherein said inputs comprise server activities and client activities.

3. The home control system of claim 1, further comprising conflict manager which controls said conflict manager for a plurality of client homes.

4. The home control system of claim 2, wherein said conflict manager synchronizes said server activities and client server activities and sets a state for said home control system based on said resolved conflicts.

5. A method for providing state based control comprising:
receiving activity inputs from a first server device;
obtaining activity inputs from a second server device;
providing specifications unit, wherein said specifications contain resolution rules for conflicts between inputs from said first and said second server devices;
comparing said first inputs to said second inputs in order to determine whether or not a conflict exists;
resolving a conflict by applying said specifications to said first and second inputs; and
re-synchronizing said first server device and said second server device based upon said resolution.

6. The method of claim 5, wherein said first and second inputs represent commands for physical devices located in a home.

7. The method of claim 6, wherein said conflict is determined based upon said inputs comprising multiple commands for the same physical device.

8. A control system comprising:
a plurality of servers;
a plurality of physical nodes;
a communications means which communicates with said plurality of physical nodes and with said servers; and
a node governor connected to said communications means, wherein said node governor filters communications provided from said client server in order that unwanted commands communicated from said communications means, does not get communicated through said node governor to said physical node.

9. The home control system of claim 8, further comprising a node simulator, said simulator comprising:
rules storage for storing rules that apply to a physical node associated with said node simulator; and
a simulation unit for processing said simulation rules for said physical node and for communicating said processed rules with said physical device and with said plurality of servers.
